(19) United States
(12) Patent Application Publication
(10) Pub. No.: US 2024/0134661 A1
(43) Pub. Date: Apr. 25, 2024

(54) MODELING A MANUFACTURING PROCESS USING SNAPSHOTS OF A SYSTEM

(71) Applicant: International Business Machines Corporation, Armonk, NY (US)

(72) Inventors: Michael M. Morin, South Burlington, VT (US); Thomas Furland, Essex Junction, VT (US); Jonathan Fry, Fishkill, NY (US)

(21) Appl. No.: 17/971,618

(22) Filed: Oct. 22, 2022

(51) Int. Cl. G06F 9/448; G06F 11/14

(52) U.S. Cl. CPC G06F 9/448; G06F 11/1479; G06F 2201/84

(57) ABSTRACT

A computer-implemented method, system and computer program product for modeling a manufacturing process. Snapshots of the system are received, where each snapshot includes a time that the snapshot was taken and a state of the system at that time. Possible transitions paths in a state diagram exhibited by the system are then identified based on the snapshots. A transition path out of the identified transition paths that most likely corresponds to the sequence of state changes exhibited by the system is selected based on information pertaining to a typical time taken by the system from one state to another. A predicted time that the system entered each state of the selected transition path between selected states of the snapshots is determined based on such information as well as the time at which the snapshots were taken. An issue related to the manufacturing process is predicted based on such predicted times.

### TECHNICAL FIELD

The present disclosure relates generally to manufacturing analysis, and more particularly to modeling a manufacturing process using snapshots of a system to perform manufacturing analysis.

### BACKGROUND

Manufacturing is the creation or production of goods with the help of equipment, labor, machines, tools, and chemical or biological processing or formulation. The term may refer to a range of human activity, from handicraft to high-tech, but it is most commonly applied to industrial design, in which raw materials from the primary sector are transformed into finished goods on a large scale. Such goods may be sold to other manufacturers for the production of other more complex products, such as aircraft, household appliances, furniture, sports equipment or automobiles, or distributed via the tertiary industry to end users and consumers, such as through wholesalers, who in turn sell to retailers, who then sell them to individual customers.

Modern manufacturing includes all intermediate processes involved in the production and integration of a product's components. Some industries, such as semiconductor and steel manufacturers, use the term “fabrication” instead.

Semiconductor device fabrication is the process used to manufacture semiconductor devices, typically integrated circuit (IC) chips, such as modern computer processors, microcontrollers, and memory chips, such as NAND flash and DRAM, that are present in everyday electrical and electronic devices. It is a multiple-step sequence of photolithographic and chemical processing steps, such as surface passivation, thermal oxidation, planar diffusion and junction isolation, during which electronic circuits are gradually created on a wafer made of pure semiconducting material. Silicon is almost always used, but various compound semiconductors are used for specialized applications.

The semiconductor manufacturing process is performed in highly specialized semiconductor fabrication plants, also called foundries or fabs. All fabrication takes place inside a clean room, which is the central part of a fab. Production in advanced fabrication facilities is completely automated and carried out in a hermetically sealed nitrogen environment to improve yield (the percent of microchips that function correctly in a wafer), with automated material handling systems taking care of the transport of wafers from machine to machine. Wafers are transported inside FOUPs (Front Opening Unified Pods), special sealed plastic boxes. All machinery and FOUPs contain an internal nitrogen atmosphere. The air inside the machinery and FOUPs is usually kept cleaner than the surrounding air in the cleanroom. This internal atmosphere is known as a mini-environment. Fabrication plants need large amounts of liquid nitrogen to maintain the atmosphere inside production machinery and FOUPs, which is constantly purged with nitrogen.

At times, the yield (the percent of microchips that function correctly in a wafer) in the semiconductor manufacturing process is poor, even as low as 5%. In such situations, an analysis, such as a fault and failure analysis, is performed to determine the cause of such a poor yield, such as margin and process variations, photolithography errors, wafer defects, etc. However, in order to properly perform the fault and failure analysis, access to all the data pertaining to the process steps is required. Unfortunately, such as in situations in which manufacturing is performed by a third party, access to such data may be limited thereby preventing a complete and thorough manufacturing analysis to identify an issue related to the manufacturing process, such as the cause of a poor yield. For example, the third party may provide a highly redacted data stream to prevent the sharing of process specifics thereby preventing a complete and thorough manufacturing analysis to identify an issue (e.g., margin and process variation) related to the manufacturing process.

### SUMMARY

In one embodiment of the present disclosure, a computer-implemented method for modeling a manufacturing process comprises receiving a plurality of snapshots of a system, where each of the plurality of snapshots comprises a time at which a snapshot was taken and a state of the system at the time. The method further comprises identifying one or more possible transition paths in a state diagram based on the plurality of snapshots of the system. The method additionally comprises selecting a first transition path from the identified one or more possible transition paths in the state diagram based on information pertaining to a typical time taken by the system to transition from one state to another and the time at which each of the plurality of snapshots was taken. Furthermore, the method comprises determining a predicted time that the system entered each state in the first transition path within selected states of the plurality of snapshots based on the information pertaining to the typical time taken by the system to transition from one state to another and the time at which each of the plurality of snapshots was taken.

In this manner, a manufacturing process is modeled using the snapshots of the system to perform manufacturing analysis. Such a manufacturing analysis may be performed to identify any issues (e.g., margin and process variations, photolithography errors, wafer defects, etc.) related to the manufacturing process. For example, the manufacturing analysis may be performed on the modeled manufacturing process to identify processor chips that have been processed with a known defective process which may be inferred based on the predicted time that the system enters particular states of the system. For example, processor chips that have been processed with a known defective process may be identified based on a time duration that exceeds a threshold amount of time between particular states of the system.

In another embodiment of the present disclosure, a computer program product for modeling a manufacturing process, where the computer program product comprises one or more computer readable storage mediums having program code embodied therewith, where the program code comprising programming instructions for receiving a plurality of snapshots of a system, where each of the plurality of snapshots comprises a time at which a snapshot was taken and a state of the system at the time. The program code further comprises the programming instructions for identifying one or more possible transition paths in a state diagram based on the plurality of snapshots of the system. The program code additionally comprises the programming instructions for selecting a first transition path from the identified one or more possible transition paths in the state diagram based on information pertaining to a typical time taken by the system to transition from one state to another and the time at which each of the plurality of snapshots was taken. Furthermore, the program code comprises the programming instructions for determining a predicted time that the system entered each state in the first transition path within selected states of the plurality of snapshots based on the information pertaining to the typical time taken by the system to transition from one state to another and the time at which each of the plurality of snapshots was taken.

In this manner, a manufacturing process is modeled using the snapshots of the system to perform manufacturing analysis. Such a manufacturing analysis may be performed to identify any issues (e.g., margin and process variations, photolithography errors, wafer defects, etc.) related to the manufacturing process. For example, the manufacturing analysis may be performed on the modeled manufacturing process to identify processor chips that have been processed with a known defective process which may be inferred based on the predicted time that the system enters particular states of the system. For example, processor chips that have been processed with a known defective process may be identified based on a time duration that exceeds a threshold amount of time between particular states of the system.

In a further embodiment of the present disclosure, a system comprises a memory for storing a computer program for modeling a manufacturing process and a processor connected to the memory. The processor is configured to execute program instructions of the computer program comprising receiving a plurality of snapshots of a system, where each of the plurality of snapshots comprises a time at which a snapshot was taken and a state of the system at the time. The processor is further configured to execute the program instructions of the computer program comprising identifying one or more possible transition paths in a state diagram based on the plurality of snapshots of the system. The processor is additionally configured to execute the program instructions of the computer program comprising selecting a first transition path from the identified one or more possible transition paths in the state diagram based on information pertaining to a typical time taken by the system to transition from one state to another and the time at which each of the plurality of snapshots was taken. Furthermore, the processor is configured to execute the program instructions of the computer program comprising determining a predicted time that the system entered each state in the first transition path within selected states of the plurality of snapshots based on the information pertaining to the typical time taken by the system to transition from one state to another and the time at which each of the plurality of snapshots was taken.

In this manner, a manufacturing process is modeled using the snapshots of the system to perform manufacturing analysis. Such a manufacturing analysis may be performed to identify any issues (e.g., margin and process variations, photolithography errors, wafer defects, etc.) related to the manufacturing process. For example, the manufacturing analysis may be performed on the modeled manufacturing process to identify processor chips that have been processed with a known defective process which may be inferred based on the predicted time that the system enters particular states of the system. For example, processor chips that have been processed with a known defective process may be identified based on a time duration that exceeds a threshold amount of time between particular states of the system.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components used by the manufacturing analysis system for modeling a manufacturing process using the snapshots of the system to perform manufacturing analysis in accordance with an embodiment of the present disclosure;

FIG. 3 illustrates a state diagram in accordance with an embodiment of the present disclosure;

FIG. 4 illustrates the sporadic snapshots of the system in accordance with an embodiment of the present disclosure;

FIGS. 5A-5B illustrate the two possible transition paths of the state diagram of FIG. 3 that the system took from state A to state B in accordance with an embodiment of the present disclosure;

FIG. 5C illustrates an impossible transition path of the state diagram of FIG. 3 that could not have been utilized by the system based on the sporadic snapshots of the system in accordance with an embodiment of the present disclosure;

FIG. 6 illustrates the typical time taken by the system between the states of the state diagram in accordance with an embodiment of the present disclosure;

FIG. 7 illustrates the specific times that the snapshots were taken in accordance with an embodiment of the present disclosure;

FIG. 8 illustrates an embodiment of the present disclosure of the hardware configuration of the manufacturing analysis system which is representative of a hardware environment for practicing the present disclosure; and

FIG. 9 is a flowchart of a method for modeling a manufacturing process using snapshots of a system to perform manufacturing analysis in accordance with an embodiment of the present disclosure.

### DETAILED DESCRIPTION

As stated in the Background section, modern manufacturing includes all intermediate processes involved in the production and integration of a product's components. Some industries, such as semiconductor and steel manufacturers, use the term “fabrication” instead.

Semiconductor device fabrication is the process used to manufacture semiconductor devices, typically integrated circuit (IC) chips, such as modern computer processors, microcontrollers, and memory chips, such as NAND flash and DRAM, that are present in everyday electrical and electronic devices. It is a multiple-step sequence of photolithographic and chemical processing steps, such as surface passivation, thermal oxidation, planar diffusion and junction isolation, during which electronic circuits are gradually created on a wafer made of pure semiconducting material. Silicon is almost always used, but various compound semiconductors are used for specialized applications.

The semiconductor manufacturing process is performed in highly specialized semiconductor fabrication plants, also called foundries or fabs. All fabrication takes place inside a clean room, which is the central part of a fab. Production in advanced fabrication facilities is completely automated and carried out in a hermetically sealed nitrogen environment to improve yield (the percent of microchips that function correctly in a wafer), with automated material handling systems taking care of the transport of wafers from machine to machine. Wafers are transported inside FOUPs (Front Opening Unified Pods), special sealed plastic boxes. All machinery and FOUPs contain an internal nitrogen atmosphere. The air inside the machinery and FOUPs is usually kept cleaner than the surrounding air in the cleanroom. This internal atmosphere is known as a mini-environment. Fabrication plants need large amounts of liquid nitrogen to maintain the atmosphere inside production machinery and FOUPs, which is constantly purged with nitrogen.

At times, the yield (the percent of microchips that function correctly in a wafer) in the semiconductor manufacturing process is poor, even as low as 5%. In such situations, an analysis, such as a fault and failure analysis, is performed to determine the cause of such a poor yield, such as margin and process variations, photolithography errors, wafer defects, etc. However, in order to properly perform the fault and failure analysis, access to all the data pertaining to the process steps is required. Unfortunately, such as in situations in which manufacturing is performed by a third party, access to such data may be limited thereby preventing a complete and thorough manufacturing analysis to identify an issue related to the manufacturing process, such as the cause of a poor yield. For example, the third party may provide a highly redacted data stream to prevent the sharing of process specifics thereby preventing a complete and thorough manufacturing analysis to identify an issue (e.g., margin and process variation) related to the manufacturing process.

The embodiments of the present disclosure provide a means for providing a complete and thorough manufacturing analysis when provided a limited amount of data, such as a highly redacted data stream, by interpolating logistics data to support manufacturing analysis using snapshots of the manufacturing system (or simply referred to herein as the “system”), where such snapshots include a time at which the snapshot was taken as well as the state of the system at that time, as discussed in further detail below.

In some embodiments of the present disclosure, the present disclosure comprises a computer-implemented method, system and computer program product for modeling a manufacturing process. In one embodiment of the present disclosure, snapshots of the system are received, where each snapshot includes a time that the snapshot was taken and a state of the system at that time. In one embodiment, such snapshots may correspond to sporadic snapshots of the process data, such as snapshots of the manufacturing process (e.g., semiconductor manufacturing process). A “snapshot,” as used herein, refers to data taken at a moment in time involving a manufacturing process, such as a semiconductor manufacturing process. A “state” may represent a step in the manufacturing process, a change in the location of an entity, a change in the composition of an entity or a business process step. Possible transitions paths in a state diagram exhibited by the system are then identified based on the snapshots of the system. A “state diagram,” as used herein, is a diagram describing the behavior of the system. A “transition path,” as used herein, refers to the sequence of state changes exhibited by the system. In one embodiment, such possible transition paths are identified based on the system states at the times of the snapshots of the system. A transition path out of the identified possible transition paths that most likely corresponds to the sequence of state changes exhibited by the system is then selected based on information pertaining to a typical time taken by the system from one state to another. For example, in one embodiment, a time difference between the states identified in the snapshots in each of the identified possible transition paths is calculated based on the information pertaining to the typical time taken by the system from one state to another. Furthermore, a time difference between each snapshot of the system is calculated. A transition path out of the identified possible transition paths that most likely corresponds to the sequence of state changes exhibited by the system is selected based on such calculated times. A predicted time that the system entered each state of the selected transition path between the selected states of the snapshots is then determined based on the information pertaining to the typical time taken by the system from one state to another as well as the time at which each of the snapshots was taken. For example, in one embodiment, transition times between the states of the selected transition path within the selected states of the snapshots is determined as a percentage of the typical time between the selected states of the snapshots. The predicted time that the system enters each of these states is determined based on the determined transition times between the states of the selected transition path within the selected states of the snapshots as well as based on the time difference between the selected states of the snapshots. An issue related to the manufacturing process (e.g., margin and process variations, photolithography errors, wafer defects, etc.) may be predicted based on the predicted time that the system entered each state between the selected states of the snapshots. For example, in one embodiment, a data structure (e.g., table) includes a listing of issues related to the manufacturing process and the times that the system entered various states. For instance, the issue of a margin and process variation may be associated with the system entering state A at 8:00 AM, entering state Z at 8:45 AM, entering state Y at 10:15 AM and entering state W at 11:00 AM. Such a data structure may be analyzed for times that match the predicted times (discussed above) for entering the same states. Such a matching result in the data structure may be associated with an issue, such as photolithography error. Alternatively, in one embodiment, a model is trained to identify an issue (e.g., margin and process variations, photolithography errors, wafer defects, etc.) related to the manufacturing process based on the predicted time that the system entered each state between the selected states of the snapshots. Based on the predicted times that the system entered each state in the system as discussed above, the trained model will output an issue related to the manufacturing process if such an issue is related to such predicted times. In this manner, a manufacturing process is modeled using the snapshots of the system to perform a manufacturing analysis. Such a manufacturing analysis may be performed to identify any issues (e.g., margin and process variations, photolithography errors, wafer defects, etc.) related to the manufacturing process.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

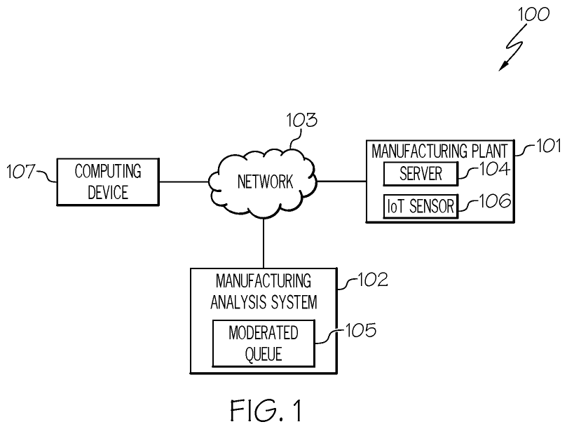

Referring now to the Figures in detail, FIG. 1 illustrates an embodiment of the present disclosure of a communication system 100 for practicing the principles of the present disclosure. Communication system 100 includes a manufacturing plant 101 connected to a manufacturing analysis system 102 via a network 103.

A “manufacturing plant” (or simply “plant”) 101, as used herein, refers to a manufacturing plant, which is an industrial facility, often a complex consisting of several buildings filled with machinery, whose workers manufacture items or operate machines which process each item into another. In the illustration of FIG. 1, the interconnection of plant 101 to manufacturing analysis system 102 via network 103 is accomplished via a server 104.

In one embodiment, server 104 stores a limited amount of data regarding the manufacturing process at a manufacturing plant, such as at manufacturing plant 101. For example, such data may include sporadic snapshots (non-periodic snapshots) of the process data, such as snapshots of the manufacturing process (e.g., semiconductor manufacturing process). A “snapshot,” as used herein, refers to data taken at a moment in time involving a manufacturing process, such as a semiconductor manufacturing process. In one embodiment, each snapshot includes a time at which the snapshot was taken as well as a state of the system at that time. A “system,” as used herein, refers to any combination of actions and processes used throughout the production of goods by manufacturing plant 101. A “state,” as used herein, refers to one or more values of one or more variable aspects of the system at an instant in time. For example, a state may involve a value concerning the lithography state or step of the manufacturing process, such as the semiconductor manufacturing process. A “state” may represent a step in the manufacturing process, a change in the location of an entity, a change in the composition of an entity or a business process step. An “entity,” as used herein, refers to a singular, identifiable and separate object, such as bits of data, system components, etc.

In one embodiment, such limited data, including snapshots of a system, such as snapshots of the manufacturing process at manufacturing plant 101, may be transmitted from manufacturing plant 101 to manufacturing analysis system 102 via network 103. In one embodiment, such snapshot data is stored in a queue, referred to herein as the “moderated queue” 105 in manufacturing analysis system 102.

A “moderated queue” 105 (also referred to as a “moderation queue”) includes content that may need to be reviewed by moderators or already has been reviewed by moderators. In one embodiment, moderated queue 105 corresponds to a data structure. In one embodiment, such moderators correspond to the users of computing device 107 connected to network 103. For example, moderated queue 105 may store information pertaining to the states of the system and the transitions between the states. Furthermore, moderated queue 105 may store information pertaining to the typical time taken by the system from one state to another. In one embodiment, such information may have been previously provided to manufacturing analysis system 102 from manufacturing plant 101 pertaining to the system via server 104. In one embodiment, manufacturing plant 101 obtains such information, such as via Internet of Things (IoT) sensors 106 placed at various steps in the manufacturing process at manufacturing plant 101.

IoT sensor 106, as used herein, refers to a sensor that can be attached to a container (e.g., container of raw materials) or a physical object (e.g., machine, raw materials, transportation vehicle) or groups of such objects that connect and exchange data with other devices and systems over a network, such as network 103. While FIG. 1 illustrates a single IoT sensor 106, manufacturing plant 101 may include any number of IoT sensors 106. In one embodiment, IoT sensors 106 are configured to monitor and/or control industrial equipment (machines) at plant 101. In one embodiment, IoT sensors 106 are utilized to acquire information to be saved in moderated queue 105, such as the states (e.g., wafer processing, oxidation, photography, etching, film deposition, interconnection, test, package, etc.) of the manufacturing process and the transitions between such states. In another embodiment, IoT sensors 106 are utilized to acquire information to be saved in moderated queue 105, such as the typical time taken by the system from one state to another. A “typical time,” as used herein, refers to the average amount of time taken by the system from one state to another. In one embodiment, the average amount of time taken by the system from one state to another is determined by acquiring the time taken by the system from one state to another at various times, such as by IoT sensors 106. For example, IoT sensors 106 may acquire the time duration taken by the system to transition from state A to state B to be 1 hour, 1 hour and 10 minutes and 50 minutes at various times (e.g., 2 pm, 3 pm, 4 pm). The average amount of time taken by the system between such states may then be determined by adding such time durations (1 hour+1 hour and 10 minutes+50 minutes=3 hours) and then dividing by the number of times that such time durations were acquired (e.g., 3).

In one embodiment, manufacturing analysis system 102 models a manufacturing process by interpolating missing data from the snapshots of the system, such as provided by manufacturing plant 101. In one embodiment, manufacturing analysis system 102 creates a state diagram describing a behavior of the system based on the information pertaining to the states of the system and the transitions between the states stored in moderated queue 105.

In one embodiment, a “state diagram,” as used herein, is a diagram describing the behavior of the system. In one embodiment, such a state diagram describes the system as a finite number of states. Furthermore, in one embodiment, such a state diagram depicts transitions between such states. In one embodiment, such a state diagram includes the typical time between such transitions.

In one embodiment, manufacturing analysis system 102 identifies one or more possible transition paths in the state diagram that most likely corresponds to the sequence of state changes exhibited by the system based on the snapshots of the system. In one embodiment, such possible transition paths are identified based on the system state at the times of the snapshots of the system as discussed further below.

In one embodiment, manufacturing analysis system 102 calculates a time difference between the states identified in the snapshots in each of the possible transition paths based on the information (stored in moderated queue 105) pertaining to the typical time taken by the system from one state to another. Furthermore, in one embodiment, manufacturing analysis system 102 calculates a time difference between the snapshots of the system. Additionally, in one embodiment, manufacturing analysis system 102 selects one of the possible transition paths in the state diagram as being the likely transition path taken by the system based on such calculated time differences. In this manner, missing data is interpolated from the provided snapshots of the system. A further description of such features is provided below.

In one embodiment, manufacturing analysis system 102 determines a predicted time that the system entered each state in the selected transition path based on the information (stored in moderated queue 105) pertaining to the typical time taken by the system from one state to another and the calculated time difference between the snapshots of the system. In this manner, missing data is interpolated from the provided snapshots of the system. A further description of such features is provided below.

In one embodiment, manufacturing analysis system 102 determines a transition time between the states of the selected transition path within the selected states of the snapshots as a percentage of the typical time between the selected states of the snapshots. In this manner, missing data is interpolated from the provided snapshots of the system. A further discussion regarding such features is provided below.

In one embodiment, manufacturing analysis system 102 determines the predicted time that the system enters such states of the selected transition path within the selected states of the snapshots based on the transition time between the states of the selected transition path within the selected states of the snapshots as a percentage of the typical time between the selected states of the snapshots as well as based on the time difference between the selected states of the snapshots. In this manner, missing data is interpolated from the provided snapshots of the system. A further discussion regarding such features is provided below.

In one embodiment, manufacturing analysis system 102 predicts an issue related to the manufacturing process based on the predicted time that the system enters such states. For example, in one embodiment, manufacturing analysis system 102 trains a model to identify issues related to the manufacturing process based on the predicted times that the system enters various states, including based on the time differences between such states. A further discussion regarding such features is provided below.

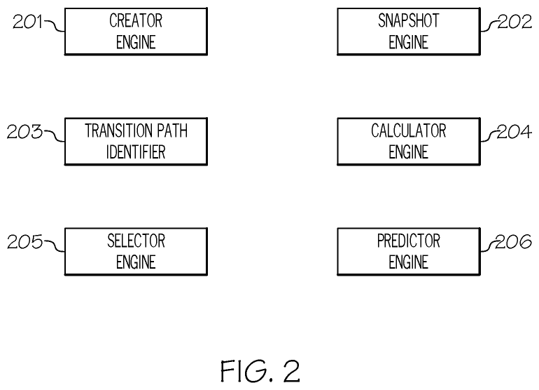

A description of the software components of manufacturing analysis system 102 used for modeling a manufacturing process using snapshots of a system to perform manufacturing analysis is provided below in connection with FIG. 2. A description of the hardware configuration of manufacturing analysis system 102 is provided further below in connection with FIG. 8.

Referring again to FIG. 1, computing device 107 is connected to manufacturing analysis system 102 via network 103. In one embodiment, the users of computing device 107 correspond to the moderators reviewing (or having previously reviewed) the data stored in moderated queue 105 as discussed above.

Computing device 107 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of connecting to network 103 and consequently communicating with other computing devices 107 and manufacturing analysis system 102. It is noted that both computing device 107 and the user of computing device 107 may be identified with element number 107.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

System 100 is not to be limited in scope to any one particular network architecture. System 100 may include any number of manufacturing plants 101, manufacturing analysis systems 102, networks 103, servers 104, moderated queues 105, IoT sensors 106 and computing devices 107.

A discussion regarding the software components used by manufacturing analysis system 102 for modeling a manufacturing process using the snapshots of a system to perform manufacturing analysis is provided below in connection with FIG. 2

FIG. 2 is a diagram of the software components used by manufacturing analysis system 102 for modeling a manufacturing process using the snapshots of a system to perform manufacturing analysis in accordance with an embodiment of the present disclosure.

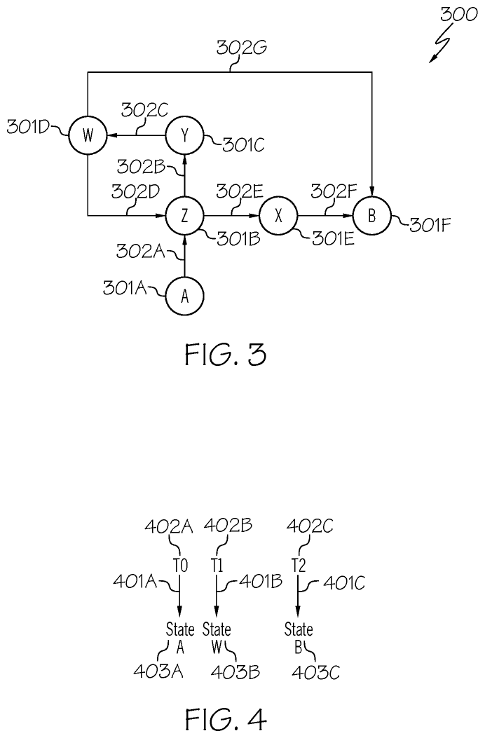

Referring to FIG. 2, in conjunction with FIG. 1, manufacturing analysis system 102 includes a creator engine 201 configured to create a state diagram describing the behavior of the system. As stated above, a “system,” as used herein, refers to any combination of actions and processes used throughout the production of goods by manufacturing plant 101. Furthermore, as discussed above, a “state diagram,” as used herein, is a diagram describing the behavior of the system. In one embodiment, such a state diagram describes the system as a finite number of states. A “state,” as used herein, refers to one or more values of one or more variable aspects of the system at an instant in time. For example, a state may involve a value concerning the lithography state or step of the manufacturing process, such as the semiconductor manufacturing process. A “state” may represent a step in the manufacturing process, a change in the location of an entity, a change in the composition of an entity or a business process step. An “entity,” as used herein, refers to a singular, identifiable and separate object, such as bits of data, system components, etc. Furthermore, in one embodiment, such a state diagram depicts transitions between such states. In one embodiment, such a state diagram includes the typical time between such transitions. An illustration of such a state diagram created by creator engine 201 is depicted in FIG. 3.

FIG. 3 illustrates a state diagram 300 in accordance with an embodiment of the present disclosure. As shown in FIG. 3, state diagram 300 includes states 301A-301F (identified as “A,” “Z,” “Y,” “W,” “X,” and “B,” respectively, in FIG. 3). Furthermore, as illustrated in FIG. 3, state diagram 300 depicts the various possible transitions between such states, such as transition 302A between states 301A, 301B, transition 302B between states 301B, 301C, transition 302C between states 301C, 301D, transition 302D between states 301D, 301B, transition 302E between states 301B, 301E, transition 302F between states 301E, 301F, and transition 302G between states 301D, 301F.

Returning to FIG. 2, in conjunction with FIGS. 1 and 3, in one embodiment, creator engine 201 creates a state diagram describing the behavior of the system, such as state diagram 300, based on information stored in moderated queue 105. In one embodiment, moderated queue 105 stores information pertaining to the states of the system and the transitions between the states. In one embodiment, such information is populated in moderated queue 105 by creator engine 201, which obtains such information from manufacturing plant 101, which obtains such information via Internet of Things (IoT) sensors 106 placed at various steps in the manufacturing process at manufacturing plant 101.

IoT sensor 106, as used herein, refers to a sensor that can be attached to a container (e.g., container of raw materials) or a physical object (e.g., machine, raw materials, transportation vehicle) or groups of such objects that connect and exchange data with other devices and systems over a network, such as network 103. In one embodiment, IoT sensors 106 are configured to monitor and/or control industrial equipment (machines) at plant 101. In one embodiment, IoT sensors 106 are utilized to acquire information to be saved in moderated queue 105, such as the states (e.g., wafer processing, oxidation, photography, etching, film deposition, interconnection, test, package, etc.) of the manufacturing process and the transitions between such states.

In one embodiment, creator engine 201 utilizes various software tools to create a state diagram, such as state diagram 300, from the information pertaining to the states of the system and the transitions between the states as stored in moderated queue 105, including, but not limited to, Diagram Maker, Creately®, etc. In one embodiment, an expert may utilize creator engine 201 to create such a state diagram using the information pertaining to the states of the system and the transitions between the states as stored in moderated queue 105.

In one embodiment, an expert creates the state diagram, such as state diagram 300, describing the behavior of the system based on analyzing information pertaining to the states of the system and the transitions between the states, which may be obtained from IoT sensors 106.

Manufacturing analysis system 102 further includes a snapshot engine 202 configured to receive snapshots of the system, where each of the snapshots includes a time that the snapshot was taken and a state of the system at that time. For example, such snapshots may correspond to sporadic snapshots (non-periodic snapshots) of the process data, such as snapshots of the manufacturing process (e.g., semiconductor manufacturing process). A “snapshot,” as used herein, refers to data taken at a moment in time involving a manufacturing process, such as a semiconductor manufacturing process. In one embodiment, each snapshot includes a time at which the snapshot was taken as well as a state of the system at that time as shown in FIG. 4.

Referring to FIG. 4, FIG. 4 illustrates the sporadic snapshots of the system in accordance with an embodiment of the present disclosure.

As shown in FIG. 4, snapshots 401A-401C of the system were taken at time TO 402A, time T1 402B and time T2 402C, respectively. Snapshots 401A-401C may collectively or individually be referred to as snapshots 401 or snapshot 401, respectively. Times 402A-402C may collectively or individually be referred to as times 402 or time 402, respectively. While FIG. 4 illustrates three snapshots 401 of the system taken at three separate times 402, any number of snapshots 401 of the system may be taken during a period of time.

Furthermore, as illustrated in FIG. 4, each snapshot 401 may include the state of the system at each time. For example, at time TO 402A, the state of the system is A (state A 403A). At time T1 402B, the state of the system is W (state W 403B). At time T2 402C, the state of the system is B (state B 403C).

Returning to FIG. 2, in conjunction with FIGS. 1 and 3-4, in one embodiment, such snapshots 401 of the system, such as snapshots of the manufacturing process at manufacturing plant 101, may be transmitted from manufacturing plant 101 to snapshot engine 202 of manufacturing analysis system 102 via network 103. In one embodiment, such snapshot data is then stored in moderated queue 105 of manufacturing analysis system 102.

In one embodiment, manufacturing plant 101 obtains sporadic snapshots 401 of the system via Internet of Things (IoT) sensors 106 placed at various steps in the manufacturing process at manufacturing plant 101. As discussed above, in one embodiment, IoT sensors 106 are configured to monitor and/or control industrial equipment (machines) at plant 101. In one embodiment, IoT sensors 106 are utilized to acquire information to be saved in moderated queue 105, such as the states (e.g., wafer processing, oxidation, photography, etching, film deposition, interconnection, test, package, etc.) of the manufacturing process and the associated times that such states were identified.

Such snapshots of the system may then be transmitted to snapshot engine 202 of manufacturing analysis system 102 from server 104 of manufacturing plant 101 via network 103.

Manufacturing analysis system 102 additionally includes a transition path identifier 203 configured to identify possible transition paths in the state diagram, such as state diagram 300, that the system may have taken based on snapshots 401 of the system. A “transition path,” as used herein, refers to the sequence of state changes exhibited by the system. In one embodiment, such possible transition paths are identified based on the system states at the times of snapshots 401 of the system as discussed below.

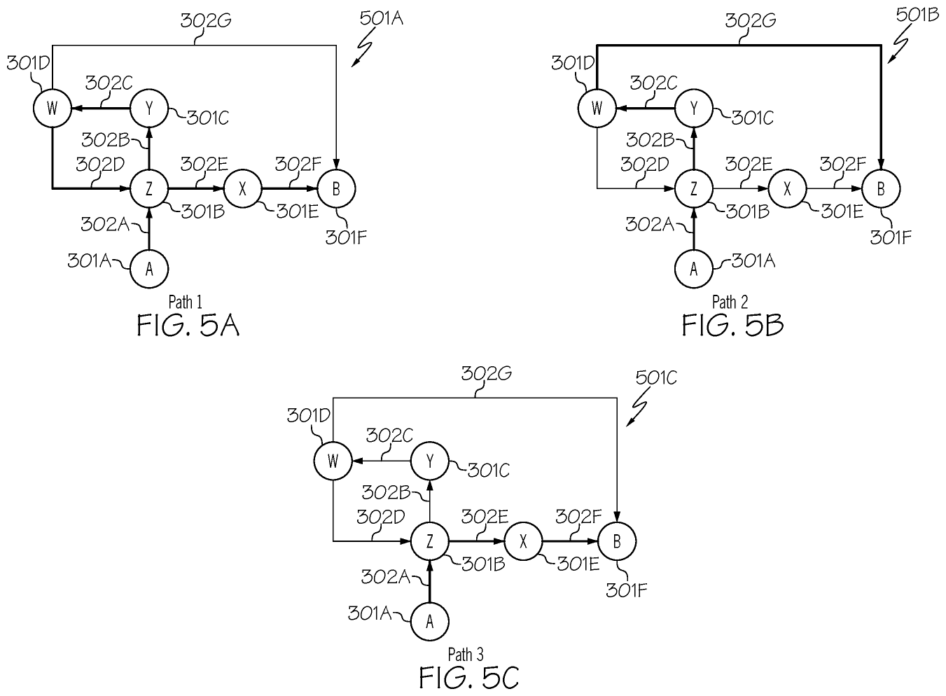

Referring to FIGS. 3 and 4, snapshots 401 of the system indicate that at time TO 402A (starting time at which snapshots 401 of the system were taken), the system was in state A 403A and at time T2 402C (ending time at which snapshots 401 of the system were taken), the system was in state B 403C. Based on state diagram 300 of the system as shown in FIG. 3, there are two possible transition paths that may have been utilized by the system based on the sporadic snapshots 401 of the system provided to snapshot engine 202 as shown in FIGS. 5A-5B. An impossible transition path that could not have been utilized by the system based on the sporadic snapshots 401 of the system provided to snapshot engine 202 is shown in FIG. 5C.

Referring to FIGS. 5A-5B, in conjunction with FIGS. 3 and 4, FIGS. 5A-5B illustrate the two possible transition paths of state diagram 300 of FIG. 3 that the system took from state A to state B in accordance with an embodiment of the present disclosure.

Referring to FIGS. 3 and 4, snapshots 401 of the system indicate that at time TO 402A, the system was in state A 403A, at time T1 402B, the system was in state W 403B and at time T2 402C, the system was in state B 403C. Based on state diagram 300 of the system as shown in FIG. 3, there are two possible transition paths that may have been utilized by the system based on the sporadic snapshots 401 of the system provided to snapshot engine 202 as shown in FIGS. 5A-5B.

As shown in FIG. 5A, FIG. 5A illustrates a first possible transition path (“Path 1”) 501A of state diagram 300 of FIG. 3 that the system took from state A to state B. Based on snapshots 401 of the system as shown in FIG. 4, it can be inferred that the system transitions from state A to state W (with other possible intermediary transitions between such states) as well as transitions from state W to state B (with other possible intermediary transitions between such states). As shown in FIG. 5A, path 1 501A includes a transition path which includes system transitions from state A 301A to state W 301D (with other intermediary transitions between such states, such as between states 301A, 301B, between states 301B, 301C and between states 301C, 301D) as well as from state W 301D to state B 301F (with other intermediary transitions between such states, such as between states 301D, 301B, between states 301B, 301E and between states 301E, 301F).

As shown in FIG. 5B, FIG. 5B illustrates a second possible transition path (“Path 2”) 501B of state diagram 300 of FIG. 3 that the system took from state A to state B. Based on snapshots 401 of the system as shown in FIG. 4, it can be inferred that the system transitions from state A to state W (with other possible intermediary transitions between such states) as well as transitions from state W to state B (with other possible intermediary transitions between such states). As shown in FIG. 5B, path 2 501B includes a transition path which includes system transitions from state A 301A to state W 301D (with other intermediary transitions between such states, such as between states 301A, 301B, between states 301B, 301C and between states 301C, 301D) as well as directly from state W 301D to state B 301F.

Referring now to FIG. 5C, FIG. 5C illustrates an impossible transition path (“Path 3”) 501C of state diagram 300 of FIG. 3 that could not have been utilized by the system based on the sporadic snapshots 401 of the system in accordance with an embodiment of the present disclosure.

Based on snapshots 401 of the system as shown in FIG. 4, it can be inferred that the system transitions from state A to state W (with other possible intermediary transitions between such states) as well as transitions from state W to state B (with other possible intermediary transitions between such states). However, as shown in FIG. 5C, path 501C does not include a transition to state W 301D. Hence, path 3 501C is not a possible transition path utilized by the system.

In one embodiment, transition path identifier 203 generates a state table that includes all the possible transitions between the starting and ending states of snapshots 401 using the state diagram, such as state diagram 300, of the system. In one embodiment, such a state table is in the form of a matrix.

In one embodiment, the state table is populated with various transitions between the states of snapshots 401 (e.g., states A, W and B) using the state diagram, such as state diagram 300, of the system for each possible path (e.g., paths 501A-501B). In one embodiment, transition path identifier 203 utilizes various software tools for populating the state table with the various transitions between the states of snapshots 401 using the state diagram, such as state diagram 300, of the system for each possible path, including, but not limited to, IBM® Rational Rhapsody, Lucidchart®, MagicDraw®, microTOOL, etc.

In one embodiment, upon populating such state tables, transition path identifier 203 generates a state diagram that highlights the various possible transition paths, such as paths 501A-501B, that the system may have taken as shown in FIGS. 5A-5B. In one embodiment, transition path identifier 203 utilizes various software tools for generating such state diagrams that highlight the various possible transition paths that the system may have taken, such as paths 501A-501B, including, but not limited to, Lucidchart®, Creately®, Gleek.io, IBM® Rational Rhapsody, etc.

Manufacturing analysis system 102 further includes a calculator engine 204 configured to calculate a time difference between the states identified in snapshots 401 in each of the identified possible transition paths based on the information pertaining to the typical time taken by the system from one state to another. In one embodiment, information pertaining to the typical time taken by the system from one state to another is obtained by IoT sensors 106 placed at various steps in the manufacturing process at manufacturing plant 101.

A “typical time,” as used herein, refers to the average amount of time taken by the system from one state to another. In one embodiment, the average amount of time taken by the system from one state to another is determined by acquiring the time taken by the system from one state to another at various times, such as by IoT sensors 106. For example, IoT sensors 106 may acquire the time duration taken by the system to transition from state A to state B to be 1 hour, 1 hour and 10 minutes and 50 minutes at various times (e.g., 2 pm, 3 pm, 4 pm). The average amount of time taken by the system between such states may then be determined by adding such time durations (1 hour+1 hour and 10 minutes+50 minutes=3 hours) and then dividing by the number of times that such time durations were acquired (e.g., 3).

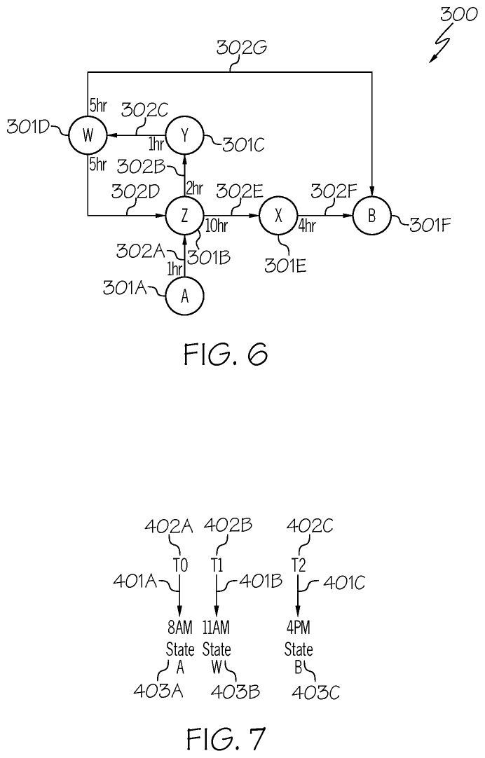

In one embodiment, such information is acquired by manufacturing plant 101 via IoT sensors 106 and transmitted to calculator engine 204 to be stored in moderated queue 105 via server 104. An example of the typical time taken by the system from one state to another, such as between the states of state diagram 300, is shown in FIG. 6.

FIG. 6 illustrates the typical time taken by the system between the states of the state diagram, such as state diagram 300 of FIG. 3, in accordance with an embodiment of the present disclosure.

Referring to FIG. 6, in conjunction with FIG. 3, state diagram 300 illustrates that the typical transition time between states 301A, 301B is 1 hour (1 hr.), the typical transition time between states 301B, 301C is 2 hours (2 hr.), the typical transition time between states 301C, 301D is 1 hour (1 hr.), the typical transition time between states 301D, 301B is 5 hours (5 hr.), the typical transition time between states 301B, 301E is 10 hours (10 hr.), the typical transition time between states 301E, 301F is 4 hours (4 hr.) and the typical transition time between states 301D, 301F is 5 hours (5 hr.).

Based on such information, calculator engine 204 calculates the time difference between the states identified in snapshots 401 of the system in each of the identified possible transition paths. For example, referring to FIGS. 4, 5A and 6, calculator engine 204 calculates the time difference between the states identified in snapshots 401, namely, states A, W and B (402A-402C, respectively) that were exhibited by the system in path 1 501A. The time difference for transitioning between states A 301A and W 301D using path 1 501A would correspond to 1 hour+2 hours+1 hour=4 hours. The time difference for transitioning between states W 301D and B 301F using path 1 501A would correspond to 5 hours+10 hours+4 hours=19 hours.

Referring now to FIGS. 4, 5B and 6, calculator engine 204 calculates the time difference between the states identified in snapshots 401, namely, states A, W and B (402A-402C, respectively) that were exhibited by the system in path 2 501B. The time difference for transitioning between states A 301A and W 301D using path 2 501B would correspond to 1 hour+2 hours+1 hour=4 hours. The time difference for transitioning between states W 301D and B 301F using path 2 501B would correspond to 5 hours.

In one embodiment, calculator engine 204 utilizes various software tools for performing such calculations, including, but not limited to, Lucidchart®, Creately®, OmniGraffle®, etc.

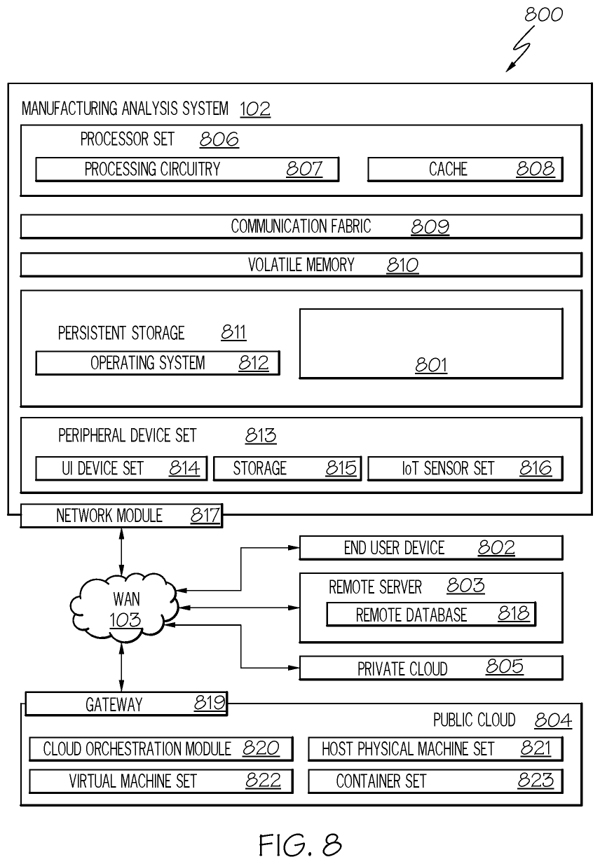

Furthermore, in one embodiment, calculator engine 204 is configured to calculate the time difference between each of the snapshots 401 of the system. In order to make such calculations, the specific times that snapshots 401 were taken need to be identified as shown in FIG. 7.

FIG. 7 illustrates the specific times that snapshots 401 were taken in accordance with an embodiment of the present disclosure.

As shown in FIG. 7, the time at which TO 402A for snapshot 401A transpired was at 8 AM, the time at which T1 402B for snapshot 401B transpired was 11 AM and the time at which T2 402C for snapshot 401C transpired was 4 PM. Hence, calculator engine 204 would determine that the time difference between snapshots 401A-401B (between states A and W) (403A, 403B, respectively) was 3 hours and the time difference between snapshots 401B-401C was 5 hours (between states W and B) (403B, 403C, respectively).

In one embodiment, an assumption is made that the time of a snapshot 401, such as 11 AM for time T1 402B, corresponds to the time that the system started in state W (identified as 403B in FIG. 7) even though it is likely that the system had started in state W prior to 11 AM. Such an assumption is made to simplify the analysis; however, other types of analyses may be made, such as assuming that the system has spent half the time in the prior state and half of the time in the current state.

In one embodiment, calculator engine 204 utilizes various software tools for performing such calculations, including, but not limited to, time difference calculator, My Alarm Clock, etc.

Returning to FIG. 2, in conjunction with FIGS. 1 and 3-4, 5A-5B and 6-7, manufacturing analysis system 102 includes a selector engine 205 configured to select one of the possible transition paths in the state diagram, such as state diagram 300, based on the calculated time difference between the states identified in snapshots 401 in each of the identified possible transition path(s) and the calculated time difference between each of the snapshots 401 of the system.

For example, referring to FIGS. 5A, 5B, 6 and 7, selector engine 205 would select path 2 501B as opposed to path 1 501A because the time difference between snapshots 401B-401C corresponding to states W and B (identified as 403B, 403C, respectively, in FIG. 7) was 5 hours and the time difference between states W and B (identified as states 301D, 301F, respectively, in state diagram 300) in path 1 501A was 19 hours; whereas, the time difference between states W and B (identified as states 301D, 301F, respectively, in state diagram 300) in path 2 501B was 5 hours, which is much closer to the time difference (5 hours) between snapshots 401B-401C corresponding to states W and B (identified as 403B, 403C, respectively, in FIG. 7).

Furthermore, it is noted that the time difference between snapshots 401A-401B corresponding to states A and W (identified as 403A, 403B, respectively, in FIG. 7) was 3 hours which is less than the time difference (4 hours) between states A and W (identified as states 301A, 301D, respectively, in state diagram 300) in paths 1 and 2 (501A, 501B, respectively). Hence, it may also be inferred that the faster path was taken by the system from state W to state B (identified as states 301D, 301F, respectively, in state diagram 300) in path 2 501B versus the slower path of path 1 501A.

In one embodiment, selector engine 205 is configured to select the transition path out of the identified possible transition paths whose time duration between the states identified in snapshots 401 is the closest to the time duration between the snapshot times for such states.

In one embodiment, selector engine 205 utilizes various software tools for selecting one of the possible transition paths in the state diagram, such as state diagram 300, based on the calculated time difference between the states identified in snapshots 401 in each of the identified possible transition path(s) and the calculated time difference between each of the snapshots 401 of the system, including, but not limited to, Lucidchart®, IBM® Rational Rhapsody, etc.

Returning to FIG. 2, in conjunction with FIGS. 1 and 3-4, 5A-5B and 6-7, manufacturing analysis system 102 further includes a predictor engine 206 configured to determine transition times between the states of the selected transition path (transition path selected by selector engine 205, such as path 2 501B) within the selected states (e.g., states A and W) of snapshots 401 as a percentage of the typical time between the selected states (e.g., states A and W) of snapshots 401. In one embodiment, such selected states (e.g., states A and W) of snapshots 401 are selected by an expert. In one embodiment, such selected states (e.g., states A and W) of snapshots 401 correspond to the states associated with snapshots 401 (e.g., snapshots 401A, 401B) randomly selected by calculator engine 204. In one embodiment, such selected states (e.g., states A and W) of snapshots 401 correspond to the states associated with snapshots 401 (e.g., snapshots 401A, 401B) that are selected by calculator engine 204 based on the occurrence of such snapshots 401, such as the first two snapshots 401.

For example, the system took 3 hours to transition between state A (identified as 403A in FIG. 7) and state W (identified as 403B in FIG. 7) according to snapshots 401 of the system as shown in FIG. 7. As previously discussed in connection with FIGS. 5B and 6, the typical time that the system transitions between states A and W (identified as 301A, 301D, respectively, in state diagram 300) using path 2 501B (selected transition path) is 4 hours. As further illustrated in FIGS. 3, 5B and 6, the system transitions between various states within the selected states of A and W. For example, the system transitions between states A and Z (301A, 301B), between states Z and Y (301B, 301C) and between states Y and W (301C, 301D). Furthermore, as illustrated in FIGS. 5B and 6, the time duration for the transition between states A and Z (301A, 301B) for the selected path (path 2 501B) is 1 hour, the time duration for the transition between states Z and Y (301B, 301C) for the selected path (path 2 501B) is 2 hours and the time duration for the transition between states Y and W (301C, 301D) for the selected path (path 2 501B) is 1 hour. Hence, the typical time duration for the system to transition between the selected states A and W for the selected path (path 2 501B) is 4 hours (total time for transitioning between the selected states, A and W, of snapshots 401). Hence, the percentage of the total typical time for the transitions between the states between the selected states, such as states A and W, of snapshots 401 is the following:
% of the total for transitioning between states A and Z is 1 hour/4 hours=25%
% of the total for transitioning between states Z and Y is 2 hours/4 hours=50%
% of the total for transitioning between states Y and W is 1 hour/4 hours=25%

Since the actual time of the transition between states A and W is 3 hours as identified by snapshots 401, the time to transition from state A to state Z is 25%*3 hours=0.75 hours (45 minutes), the time to transition from state Z to state Y is 50%*3 hours=1.5 hours, and the time to transition from state Y to state W is 25%*3 hours=0.75 hours (45 minutes).

Based on such information, in one embodiment, predictor engine 206 determines a predicted time that the system entered each state of the selected transition path (e.g., path 2 501B) between the selected states (e.g., states A, W) of snapshots 401 based on the time difference between the selected states (e.g., states A, W) of snapshots 401.

For example, as illustrated in FIG. 7, it took 3 hours for the system to transition between states A and W (403A, 403B, respectively). Furthermore, as illustrated in FIG. 7, snapshot 401A indicates that time TO 402A (corresponding to state A) occurred at 8 AM and snapshot 401B indicates that time T1 402B (corresponding to state W) occurred at 11 AM. In one embodiment, it is assumed that the time of a snapshot 401, such as 11 AM for time T1 402B, corresponds to the time that the system started in state W (identified as 403B in FIG. 7). Based on such information and assumptions as well as the transition times between the states (e.g., transition time between states A and Z is 45 minutes, transition time between states Z and Y is 1.5 hours and transition time between states Y and W is 45 minutes) of the selected transition path (e.g., path 2 501B), predictor engine 206 determines that the system entered state A at 8 AM (obtained from snapshot 401A), entered state Z at 8:45 AM (transition time between states A and Z is 45 minutes), entered state Y at 10:15 AM (transition time between states Z and Y is 1.5 hours) and entered state W at 11:00 AM (transition time between states Y and W is 45 minutes) (corresponds to the time at snapshot 401B).

In one embodiment, predictor engine 206 is configured to determine such features using various software tools, including, but not limited to, time difference calculator, My Alarm Clock percentage calc, etc.

Furthermore, in one embodiment, predictor engine 206 is configured to predict an issue related to the manufacturing process based on the predicted time that the system entered each state between the selected states of snapshots 401.

For example, as discussed above, predictor engine 206 may determine that the system entered state A at 8 AM (obtained from snapshot 401A), entered state Z at 8:45 AM (transition time between states A and Z is 45 minutes), entered state Y at 10:15 AM (transition time between states Z and Y is 1.5 hours) and entered state W at 11:00 AM (transition time between states Y and W is 45 minutes) (corresponds to the time at snapshot 401B). Based on such time durations between such states, predictor engine 206 may determine if there is an issue related to the manufacturing process (e.g., margin and process variations, photolithography errors, wafer defects, etc.).

In one embodiment, a data structure (e.g., table) includes a listing of issues related to the manufacturing process and the times that the system entered various states. For example, the issue of a margin and process variation may be associated with the system entering state A at 8:00 AM, entering state Z at 8:45 AM, entering state Y at 10:15 AM and entering state W at 11:00 AM. In one embodiment, predictor engine 206 analyzes the data structure for times that match the predicted times (discussed above) for entering the same states. Such a matching result in the data structure may be associated with an issue, such as a photolithography error. In this manner, predictor engine 206 is able to identify an issue (e.g., photolithography error). In one embodiment, such a data structure is populated by an expert. In one embodiment, such a data structure resides within the storage device (e.g., memory, disk unit) of manufacturing analysis system 102.

In one embodiment, a data structure (e.g., table) includes a listing of issues related to the manufacturing process and the time differences between the states transitioned by the system during the manufacturing process. For example, based on entering states A, Z, Y and W at 8 AM, 8:45 AM, 10:15 AM and 11 AM, respectively, it can be inferred that it took 45 minutes to transition between states A and Z, took 1.5 hours to transition between states Z and Y and took 45 minutes to transition between states Y and W. In one embodiment, predictor engine 206 analyzes the data structure for time durations that match the time durations between the predicted times (discussed above) for the states entered by the system. For example, predictor engine 206 analyzes the data structure for matching the time duration of 45 minutes to transition between states A and Z, the time duration of 1.5 hours to transition between states Z and Y and the time duration of 45 minutes to transition between states Y and W. Such matching time durations may result in identifying an issue (e.g., photolithography error) in the data structure. In this manner, predictor engine 206 is able to identify an issue (e.g., photolithography error). In one embodiment, such a data structure is populated by an expert. In one embodiment, such a data structure resides within the storage device (e.g., memory, disk unit) of manufacturing analysis system 102.

In one embodiment, predictor engine 206 trains a model to identify an issue (e.g., margin and process variations, photolithography errors, wafer defects, etc.) related to the manufacturing process based on the predicted time that the system entered each state between the selected states of snapshots 401.

In one embodiment, predictor engine 206 uses a machine learning algorithm (e.g., supervised learning) to build the model to identify an issue (e.g., margin and process variations, photolithography errors, wafer defects, etc.) related to the manufacturing process using a sample data set containing predicted times that the system entered each state.

Such a sample data set is referred to herein as the “training data,” which is used by the machine learning algorithm to make predictions or decisions as to the issue (e.g., margin and process variations, photolithography errors, wafer defects, etc.) related to the manufacturing process based on the predicted time that the system entered each state between the selected states of snapshots 401. The algorithm iteratively makes predictions on the training data as to the issue (e.g., margin and process variations, photolithography errors, wafer defects, etc.) related to the manufacturing process based on the predicted time that the system entered each state between the selected states of snapshots 401. Examples of such learning algorithms include nearest neighbor, Naïve Bayes, decision trees, linear regression, support vector machines and neural networks.

In one embodiment, after training the model to identify an issue (e.g., margin and process variations, photolithography errors, wafer defects, etc.) related to the manufacturing process based on the predicted time that the system entered each state between the selected states of snapshots 401, predictor engine 206 inputs the predicted time that the system entered each state of the selected transition path (e.g., transition path 501B) within the selected states of snapshots 401 to the model. The model then outputs an issue related to the manufacturing process if such an issue is related to such predicted times.

A further description of these and other features is provided below in connection with the discussion of the method for modeling a manufacturing process using snapshots of a system to perform manufacturing analysis.

Prior to the discussion of the method for modeling a manufacturing process using snapshots of a system to perform manufacturing analysis, a description of the hardware configuration of manufacturing analysis system 102 (FIG. 1) is provided below in connection with FIG. 8.

Referring now to FIG. 8, in conjunction with FIG. 1, FIG. 8 illustrates an embodiment of the present disclosure of the hardware configuration of manufacturing analysis system 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code 801 involved in performing the inventive methods, such as modeling a manufacturing process using snapshots of a system to perform manufacturing analysis. In addition to block 801, computing environment 800 includes, for example, manufacturing analysis system 102, network 103, such as a wide area network (WAN), end user device (EUD) 802, remote server 803, public cloud 804, and private cloud 805. In this embodiment, manufacturing analysis system 102 includes processor set 806 (including processing circuitry 807 and cache 808), communication fabric 809, volatile memory 810, persistent storage 811 (including operating system 812 and block 801, as identified above), peripheral device set 813 (including user interface (UI) device set 814, storage 815, and Internet of Things (IoT) sensor set 816), and network module 817. Remote server 803 includes remote database 818. Public cloud 804 includes gateway 819, cloud orchestration module 820, host physical machine set 821, virtual machine set 822, and container set 823.

Manufacturing analysis system 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 818. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically manufacturing analysis system 102, to keep the presentation as simple as possible. Manufacturing analysis system 102 may be located in a cloud, even though it is not shown in a cloud in FIG. 8. On the other hand, manufacturing analysis system 102 is not required to be in a cloud except to any extent as may be affirmatively indicated.

Processor set 806 includes one, or more, computer processors of any type now known or to be developed in the future. Processing circuitry 807 may be distributed over multiple packages, for example, multiple, coordinated integrated circuit chips. Processing circuitry 807 may implement multiple processor threads and/or multiple processor cores. Cache 808 is memory that is located in the processor chip package(s) and is typically used for data or code that should be available for rapid access by the threads or cores running on processor set 806. Cache memories are typically organized into multiple levels depending upon relative proximity to the processing circuitry. Alternatively, some, or all, of the cache for the processor set may be located “off chip.” In some computing environments, processor set 806 may be designed for working with qubits and performing quantum computing.

Computer readable program instructions are typically loaded onto manufacturing analysis system 102 to cause a series of operational steps to be performed by processor set 806 of manufacturing analysis system 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 808 and the other storage media discussed below. The program instructions, and associated data, are accessed by processor set 806 to control and direct performance of the inventive methods. In computing environment 800, at least some of the instructions for performing the inventive methods may be stored in block 801 in persistent storage 811.

Communication fabric 809 is the signal conduction paths that allow the various components of manufacturing analysis system 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 810 is any type of volatile memory now known or to be developed in the future. Examples include dynamic type random access memory (RAM) or static type RAM. Typically, the volatile memory is characterized by random access, but this is not required unless affirmatively indicated. In manufacturing analysis system 102, the volatile memory 810 is located in a single package and is internal to manufacturing analysis system 102, but, alternatively or additionally, the volatile memory may be distributed over multiple packages and/or located externally with respect to manufacturing analysis system 102.

Persistent Storage 811 is any form of non-volatile storage for computers that is now known or to be developed in the future. The non-volatility of this storage means that the stored data is maintained regardless of whether power is being supplied to manufacturing analysis system 102 and/or directly to persistent storage 811. Persistent storage 811 may be a read only memory (ROM), but typically at least a portion of the persistent storage allows writing of data, deletion of data and re-writing of data. Some familiar forms of persistent storage include magnetic disks and solid state storage devices. Operating system 812 may take several forms, such as various known proprietary operating systems or open source Portable Operating System Interface type operating systems that employ a kernel. The code included in block 801 typically includes at least some of the computer code involved in performing the inventive methods.

Peripheral device set 813 includes the set of peripheral devices of manufacturing analysis system 102. Data communication connections between the peripheral devices and the other components of manufacturing analysis system 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 814 may include components such as a display screen, speaker, microphone, wearable devices (such as goggles and smart watches), keyboard, mouse, printer, touchpad, game controllers, and haptic devices. Storage 815 is external storage, such as an external hard drive, or insertable storage, such as an SD card. Storage 815 may be persistent and/or volatile. In some embodiments, storage 815 may take the form of a quantum computing storage device for storing data in the form of qubits. In embodiments where manufacturing analysis system 102 is required to have a large amount of storage (for example, where manufacturing analysis system 102 locally stores and manages a large database) then this storage may be provided by peripheral storage devices designed for storing very large amounts of data, such as a storage area network (SAN) that is shared by multiple, geographically distributed computers. IoT sensor set 816 is made up of sensors that can be used in Internet of Things applications. For example, one sensor may be a thermometer and another sensor may be a motion detector.

Network module 817 is the collection of computer software, hardware, and firmware that allows manufacturing analysis system 102 to communicate with other computers through WAN 103. Network module 817 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 817 are performed on the same physical hardware device. In other embodiments (for example, embodiments that utilize software-defined networking (SDN)), the control functions and the forwarding functions of network module 817 are performed on physically separate devices, such that the control functions manage several different network hardware devices. Computer readable program instructions for performing the inventive methods can typically be downloaded to manufacturing analysis system 102 from an external computer or external storage device through a network adapter card or network interface included in network module 817.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 802 is any computer system that is used and controlled by an end user (for example, a customer of an enterprise that operates manufacturing analysis system 102), and may take any of the forms discussed above in connection with manufacturing analysis system 102. EUD 802 typically receives helpful and useful data from the operations of manufacturing analysis system 102. For example, in a hypothetical case where manufacturing analysis system 102 is designed to provide a recommendation to an end user, this recommendation would typically be communicated from network module 817 of manufacturing analysis system 102 through WAN 103 to EUD 802. In this way, EUD 802 can display, or otherwise present, the recommendation to an end user. In some embodiments, EUD 802 may be a client device, such as thin client, heavy client, mainframe computer, desktop computer and so on.

Remote server 803 is any computer system that serves at least some data and/or functionality to manufacturing analysis system 102. Remote server 803 may be controlled and used by the same entity that operates manufacturing analysis system 102. Remote server 803 represents the machine(s) that collect and store helpful and useful data for use by other computers, such as manufacturing analysis system 102. For example, in a hypothetical case where manufacturing analysis system 102 is designed and programmed to provide a recommendation based on historical data, then this historical data may be provided to manufacturing analysis system 102 from remote database 818 of remote server 803.

Public cloud 804 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 804 is performed by the computer hardware and/or software of cloud orchestration module 820. The computing resources provided by public cloud 804 are typically implemented by virtual computing environments that run on various computers making up the computers of host physical machine set 821, which is the universe of physical computers in and/or available to public cloud 804. The virtual computing environments (VCEs) typically take the form of virtual machines from virtual machine set 822 and/or containers from container set 823. It is understood that these VCEs may be stored as images and may be transferred among and between the various physical machine hosts, either as images or after instantiation of the VCE. Cloud orchestration module 820 manages the transfer and storage of images, deploys new instantiations of VCEs and manages active instantiations of VCE deployments. Gateway 819 is the collection of computer software, hardware, and firmware that allows public cloud 804 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 805 is similar to public cloud 804, except that the computing resources are only available for use by a single enterprise. While private cloud 805 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 804 and private cloud 805 are both part of a larger hybrid cloud.

Block 801 further includes the software components discussed above in connection with FIGS. 2-4, 5A-5C and 6-7 to model a manufacturing process using snapshots of a system to perform manufacturing analysis. In one embodiment, such components may be implemented in hardware. The functions discussed above performed by such components are not generic computer functions. As a result, manufacturing analysis system 102 is a particular machine that is the result of implementing specific, non-generic computer functions.

In one embodiment, the functionality of such software components of manufacturing analysis system 102, including the functionality for modeling a manufacturing process using snapshots of a system to perform manufacturing analysis may be embodied in an application specific integrated circuit.

As stated above, modern manufacturing includes all intermediate processes involved in the production and integration of a product's components. Some industries, such as semiconductor and steel manufacturers, use the term “fabrication” instead. Semiconductor device fabrication is the process used to manufacture semiconductor devices, typically integrated circuit (IC) chips, such as modern computer processors, microcontrollers, and memory chips, such as NAND flash and DRAM, that are present in everyday electrical and electronic devices. It is a multiple-step sequence of photolithographic and chemical processing steps, such as surface passivation, thermal oxidation, planar diffusion and junction isolation, during which electronic circuits are gradually created on a wafer made of pure semiconducting material. Silicon is almost always used, but various compound semiconductors are used for specialized applications. The semiconductor manufacturing process is performed in highly specialized semiconductor fabrication plants, also called foundries or fabs. All fabrication takes place inside a clean room, which is the central part of a fab. Production in advanced fabrication facilities is completely automated and carried out in a hermetically sealed nitrogen environment to improve yield (the percent of microchips that function correctly in a wafer), with automated material handling systems taking care of the transport of wafers from machine to machine. Wafers are transported inside FOUPs (Front Opening Unified Pods), special sealed plastic boxes. All machinery and FOUPs contain an internal nitrogen atmosphere. The air inside the machinery and FOUPs is usually kept cleaner than the surrounding air in the cleanroom. This internal atmosphere is known as a mini-environment. Fabrication plants need large amounts of liquid nitrogen to maintain the atmosphere inside production machinery and FOUPs, which is constantly purged with nitrogen. At times, the yield (the percent of microchips that function correctly in a wafer) in the semiconductor manufacturing process is poor, even as low as 5%. In such situations, an analysis, such as a fault and failure analysis, is performed to determine the cause of such a poor yield, such as margin and process variations, photolithography errors, wafer defects, etc. However, in order to properly perform the fault and failure analysis, access to all the data pertaining to the process steps is required. Unfortunately, such as in situations in which manufacturing is performed by a third party, access to such data may be limited thereby preventing a complete and thorough manufacturing analysis to identify an issue related to the manufacturing process, such as the cause of a poor yield. For example, the third party may provide a highly redacted data stream to prevent the sharing of process specifics thereby preventing a complete and thorough manufacturing analysis to identify an issue (e.g., margin and process variation) related to the manufacturing process.

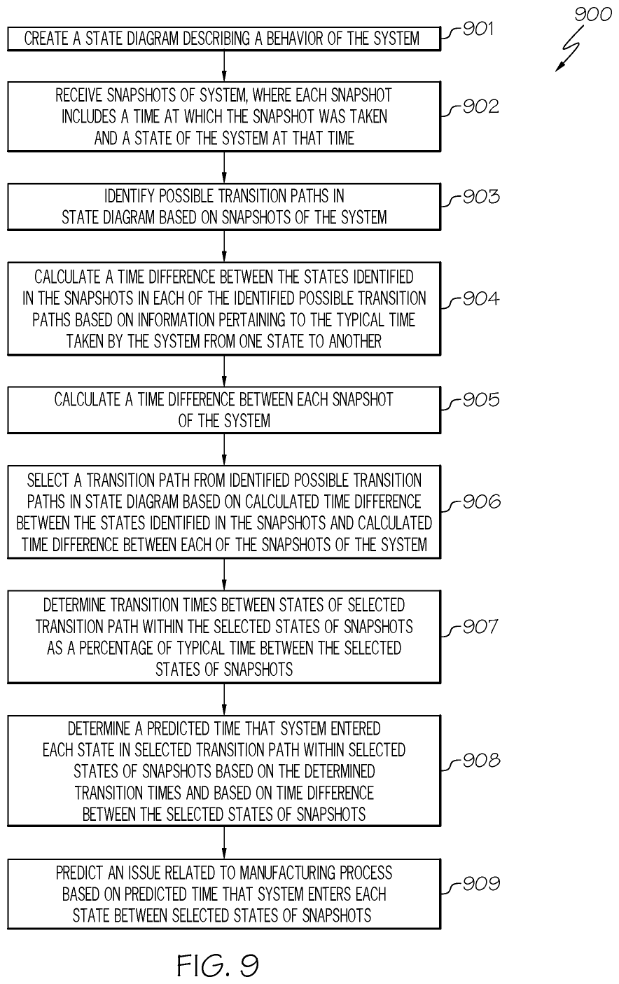

The embodiments of the present disclosure provide a means for providing a complete and thorough manufacturing analysis when provided a limited amount of data, such as a highly redacted data stream, by interpolating logistics data to support manufacturing analysis using snapshots of the manufacturing system (or simply referred to as “system”), where such snapshots include a time at which the snapshot was taken as well as the state of the system at that time, as discussed below in connection with FIG. 9.

FIG. 9 is a flowchart of a method 900 for modeling a manufacturing process using snapshots of a system to perform manufacturing analysis in accordance with an embodiment of the present disclosure.

Referring to FIG. 9, in conjunction with FIGS. 1-4, 5A-5C and 6-8, in operation 901, creator engine 201 of manufacturing analysis system 102 creates a state diagram, such as state diagram 300, describing the behavior of the system.

As stated above, a “system,” as used herein, refers to any combination of actions and processes used throughout the production of goods by manufacturing plant 101. Furthermore, as discussed above, a “state diagram,” as used herein, is a diagram describing the behavior of the system. In one embodiment, such a state diagram describes the system as a finite number of states. A “state,” as used herein, refers to one or more values of one or more variable aspects of the system at an instant in time. For example, a state may involve a value concerning the lithography state or step of the manufacturing process, such as the semiconductor manufacturing process. A “state” may represent a step in the manufacturing process, a change in the location of an entity, a change in the composition of an entity or a business process step. An “entity,” as used herein, refers to a singular, identifiable and separate object, such as bits of data, system components, etc. Furthermore, in one embodiment, such a state diagram depicts transitions between such states. In one embodiment, such a state diagram includes the typical time between such transitions. An illustration of such a state diagram created by creator engine 201 is depicted in FIG. 3.

Furthermore, as discussed above, in one embodiment, creator engine 201 creates a state diagram describing the behavior of the system, such as state diagram 300, based on information stored in moderated queue 105. In one embodiment, moderated queue 105 stores information pertaining to the states of the system and the transitions between the states. In one embodiment, such information is populated in moderated queue 105 by creator engine 201, which obtains such information from manufacturing plant 101, which obtains such information via Internet of Things (IoT) sensors 106 placed at various steps in the manufacturing process at manufacturing plant 101.

IoT sensor 106, as used herein, refers to a sensor that can be attached to a container (e.g., container of raw materials) or a physical object (e.g., machine, raw materials, transportation vehicle) or groups of such objects that connect and exchange data with other devices and systems over a network, such as network 103. In one embodiment, IoT sensors 106 are configured to monitor and/or control industrial equipment (machines) at plant 101. In one embodiment, IoT sensors 106 are utilized to acquire information to be saved in moderated queue 105, such as the states (e.g., wafer processing, oxidation, photography, etching, film deposition, interconnection, test, package, etc.) of the manufacturing process and the transitions between such states.

In one embodiment, creator engine 201 utilizes various software tools to create a state diagram, such as state diagram 300, from the information pertaining to the states of the system and the transitions between the states as stored in moderated queue 105, including, but not limited to, Diagram Maker, Creately®, etc. In one embodiment, an expert may utilize creator engine 201 to create such a state diagram using the information pertaining to the states of the system and the transitions between the states as stored in moderated queue 105.

In one embodiment, an expert creates the state diagram, such as state diagram 300, describing the behavior of the system based on analyzing information pertaining to the states of the system and the transitions between the states, which may be obtained from IoT sensors 106.

In operation 902, snapshot engine 202 of manufacturing analysis system 102 receives snapshots 401 of the system, where each snapshot 401 includes a time 402 at which snapshot 401 was taken and a state 403 of the system at that time.

For example, such snapshots 401 may correspond to sporadic snapshots of the process data, such as snapshots of the manufacturing process (e.g., semiconductor manufacturing process). A “snapshot” 401, as used herein, refers to data taken at a moment in time involving a manufacturing process, such as a semiconductor manufacturing process. In one embodiment, each snapshot 401 includes a time at which snapshot 401 was taken as well as a state of the system at that time as shown in FIG. 4.

Furthermore, as discussed above, in one embodiment, such snapshots 401 of the system, such as snapshots of the manufacturing process at manufacturing plant 101, may be transmitted from manufacturing plant 101 to snapshot engine 202 of manufacturing analysis system 102 via network 103. In one embodiment, such snapshot data is then stored in moderated queue 105 of manufacturing analysis system 102.

In one embodiment, manufacturing plant 101 obtains sporadic snapshots 401 of the system via Internet of Things (IoT) sensors 106 placed at various steps in the manufacturing process at manufacturing plant 101. As discussed above, in one embodiment, IoT sensors 106 are configured to monitor and/or control industrial equipment (machines) at plant 101. In one embodiment, IoT sensors 106 are utilized to acquire information to be saved in moderated queue 105, such as the states (e.g., wafer processing, oxidation, photography, etching, film deposition, interconnection, test, package, etc.) of the manufacturing process and the associated times that such states were identified.

Such snapshots of the system may then be transmitted to snapshot engine 202 of manufacturing analysis system 102 from server 104 of manufacturing plant 101 via network 103.

In operation 903, transition path identifier 203 of manufacturing analysis system 102 identifies possible transition paths in the state diagram, such as state diagram 300, based on snapshots 401 of the system.

As stated above, a “transition path,” as used herein, refers to the sequence of state changes exhibited by the system. In one embodiment, such possible transition paths are identified based on the system states at the times of snapshots 401 of the system as discussed below.

Referring to FIGS. 3 and 4, snapshots 401 of the system indicate that at time TO 402A (starting time at which snapshots 401 of the system were taken), the system was in state A 403A and at time T2 402C (ending time at which snapshots 401 of the system were taken), the system was in state B 403C. Based on state diagram 300 of the system as shown in FIG. 3, there are two possible transition paths that may have been utilized by the system based on the sporadic snapshots 401 of the system provided to snapshot engine 202 as shown in FIGS. 5A-5B. An impossible transition path that could not have been utilized by the system based on the sporadic snapshots 401 of the system provided to snapshot engine 202 is shown in FIG. 5C.

Referring to FIGS. 5A-5B, in conjunction with FIGS. 3 and 4, FIGS. 5A-5B illustrate the two possible transition paths that the system took from state A to state B in accordance with an embodiment of the present disclosure.

Referring to FIGS. 3 and 4, snapshots 401 of the system indicate that at time TO 402A, the system was in state A 403A, at time T1 402B, the system was in state W 403B and at time T2 402C, the system was in state B 403C. Based on state diagram 300 of the system as shown in FIG. 3, there are two possible transition paths that may have been utilized by the system based on the sporadic snapshots 401 of the system provided to snapshot engine 202 as shown in FIGS. 5A-5B.

As shown in FIG. 5A, FIG. 5A illustrates a first possible transition path (“Path 1”) 501A of state diagram 300 of FIG. 3 that the system took from state A to state B. Based on snapshots 401 of the system as shown in FIG. 4, it can be inferred that the system transitions from state A to state W (with other possible intermediary transitions between such states) as well as transitions from state W to state B (with other possible intermediary transitions between such states). As shown in FIG. 5A, path 1 501A includes a transition path which includes system transitions from state A 301A to state W 301D (with other intermediary transitions between such states, such as between states 301A, 301B, between states 301B, 301C and between states 301C, 301D) as well as from state W 301D to state B 301F (with other intermediary transitions between such states, such as between states 301D, 301B, between states 301B, 301E and between states 301E, 301F).

As shown in FIG. 5B, FIG. 5B illustrates a second possible transition path (“Path 2”) 501B of state diagram 300 of FIG. 3 that the system took from state A to state B. Based on snapshots 401 of the system as shown in FIG. 4, it can be inferred that the system transitions from state A to state W (with other possible intermediary transitions between such states) as well as transitions from state W to state B (with other possible intermediary transitions between such states). As shown in FIG. 5B, path 2 501B includes a transition path which includes system transitions from state A 301A to state W 301D (with other intermediary transitions between such states, such as between states 301A, 301B, between states 301B, 301C and between states 301C, 301D) as well as directly from state W 301D to state B 301F.

Referring now to FIG. 5C, FIG. 5C illustrates an impossible transition path (“Path 3”) 501C of state diagram 300 of FIG. 3 that could not have been utilized by the system based on the sporadic snapshots 401 of the system in accordance with an embodiment of the present disclosure.

Based on snapshots 401 of the system as shown in FIG. 4, it can be inferred that the system transitions from state A to state W (with other possible intermediary transitions between such states) as well as transitions from state W to state B (with other possible intermediary transitions between such states). However, as shown in FIG. 5C, path 501C does not include a transition to state W 301D. Hence, path 3 501C is not a possible transition path utilized by the system.

As stated above, in one embodiment, transition path identifier 203 generates a state table that includes all the possible transitions between the starting and ending states of snapshots 401 using the state diagram, such as state diagram 300, of the system. In one embodiment, such a state table is in the form of a matrix.

In one embodiment, the state table is populated with various transitions between the states of snapshots 401 (e.g., states A, W and B) using the state diagram, such as state diagram 300, of the system for each possible path (e.g., paths 501A-501B). In one embodiment, transition path identifier 203 utilizes various software tools for populating the state table with the various transitions between the states of snapshots 401 using the state diagram, such as state diagram 300, of the system for each possible path, including, but not limited to, IBM® Rational Rhapsody, Lucidchart®, MagicDraw®, microTOOL, etc.

In one embodiment, upon populating such state tables, transition path identifier 203 generates a state diagram that highlights the various possible transition paths, such as paths 501A-501B, that the system may have taken as shown in FIGS. 5A-5B. In one embodiment, transition path identifier 203 utilizes various software tools for generating such state diagrams that highlight the various possible transition paths that the system may have taken, such as paths 501A-501B, including, but not limited to, Lucidchart®, Creately®, Gleek.io, IBM® Rational Rhapsody, etc.

In operation 904, calculator engine 204 of manufacturing analysis system 102 calculates a time difference between the states identified in snapshots 401 in each of the identified possible transition paths based on information pertaining to the typical time taken by the system from one state to another.

As stated above, in one embodiment, information pertaining to the typical time taken by the system from one state to another is obtained by IoT sensors 106 placed at various steps in the manufacturing process at manufacturing plant 101. A “typical time,” as used herein, refers to the average amount of time taken by the system from one state to another. In one embodiment, the average amount of time taken by the system from one state to another is determined by acquiring the time taken by the system from one state to another at various times, such as by IoT sensors 106. For example, IoT sensors 106 may acquire the time duration taken by the system to transition from state A to state B to be 1 hour, 1 hour and 10 minutes and 50 minutes at various times (e.g., 2 pm, 3 pm, 4 pm). The average amount of time taken by the system between such states may then be determined by adding such time durations (1 hour+1 hour and 10 minutes+50 minutes=3 hours) and then dividing by the number of times that such time durations were acquired (e.g., 3).

In one embodiment, such information is acquired by manufacturing plant 101 via IoT sensors 106 and transmitted to calculator engine 204 to be stored in moderated queue 105 via server 104. An example of the typical time taken by the system from one state to another, such as between the states of state diagram 300, is shown in FIG. 6.

FIG. 6 illustrates the typical time taken by the system between the states of the state diagram, such as state diagram 300 of FIG. 3, in accordance with an embodiment of the present disclosure.

Referring to FIG. 6, in conjunction with FIG. 3, state diagram 300 illustrates that the typical transition time between states 301A, 301B is 1 hour (1 hr.), the typical transition time between states 301B, 301C is 2 hours (2 hr.), the typical transition time between states 301C, 301D is 1 hour (1 hr.), the typical transition time between states 301D, 301B is 5 hours (5 hr.), the typical transition time between states 301B, 301E is 10 hours (10 hr.), the typical transition time between states 301E, 301F is 4 hours (4 hr.) and the typical transition time between states 301D, 301F is 5 hours (5 hr.).

Based on such information, calculator engine 204 calculates the time difference between the states identified in snapshots 401 of the system in each of the identified possible transition paths. For example, referring to FIGS. 4, 5A and 6, calculator engine 204 calculates the time difference between the states identified in snapshots 401, namely, states A, W and B (402A-402C, respectively) that were exhibited by the system in path 1 501A. The time difference for transitioning between states A 301A and W 301D using path 1 501A would correspond to 1 hour+2 hours+1 hour=4 hours. The time difference for transitioning between states W 301D and B 301F using path 1 501A would correspond to 5 hours+10 hours+4 hours=19 hours.

Referring now to FIGS. 4, 5B and 6, calculator engine 204 calculates the time difference between the states identified in snapshots 401, namely, states A, W and B (402A-402C, respectively) that were exhibited by the system in path 2 501B. The time difference for transitioning between states A 301A and W 301D using path 2 501B would correspond to 1 hour+2 hours+1 hour=4 hours. The time difference for transitioning between states W 301D and B 301F using path 2 501B would correspond to 5 hours.

In one embodiment, calculator engine 204 utilizes various software tools for performing such calculations, including, but not limited to, Lucidchart®, Creately®, OmniGraffle®, etc.

In operation 905, calculator engine 204 of manufacturing analysis system 102 calculates the time difference between each snapshot 401 of the system, including between selected states of snapshots 401.

For example, referring to FIG. 7, FIG. 7 illustrates the specific times that snapshots 401 were taken in accordance with an embodiment of the present disclosure. As shown in FIG. 7, the time at which TO 402A for snapshot 401A transpired was at 8 AM, the time at which T1 402B for snapshot 401B transpired was 11 AM and the time at which T2 402C for snapshot 401C transpired was 4 PM. Hence, calculator engine 204 would determine that the time difference between snapshots 401A-401B (between states A and W) (403A, 403B, respectively) was 3 hours and the time difference between snapshots 401B-401C was 5 hours (between states W and B) (403B, 403C, respectively).

As discussed above, in one embodiment, an assumption is made that the time of a snapshot 401, such as 11 AM for time T1 402B, corresponds to the time that the system started in state W (identified as 403B in FIG. 7) even though it is likely that the system had started in state W prior to 11 AM. Such an assumption is made to simplify the analysis; however, other types of analyses may be made, such as assuming that the system has spent half the time in the prior state and half of the time in the current state.

As discussed further below, in one embodiment, particular states (e.g., states A and W) of snapshots 401 may be selected upon which to determine a predicted time that the system entered each state in the selected transition path (e.g., transition path 501B) within such selected states. As a result, calculator engine 204 calculates the time difference between such selected states (e.g., between states A and W 403A, 403B) as discussed above. In one embodiment, such selected states (e.g., states A and W) of snapshots 401 are selected by an expert. In one embodiment, such selected states (e.g., states A and W) of snapshots 401 correspond to the states associated with snapshots 401 (e.g., snapshots 401A, 401B) randomly selected by calculator engine 204. In one embodiment, such selected states (e.g., states A and W) of snapshots 401 correspond to the states associated with snapshots 401 (e.g., snapshots 401A, 401B) that are selected by calculator engine 204 based on the occurrence of such snapshots 401, such as the first two snapshots 401.

In one embodiment, calculator engine 204 utilizes various software tools for performing such calculations, including, but not limited to, time difference calculator, My Alarm Clock, etc.

In operation 906, selector engine 205 of manufacturing analysis system 102 selects one of the possible transition paths in the state diagram, such as state diagram 300, based on the calculated time difference between the states identified in snapshots 401 and the calculated time difference between each of the snapshots 401 of the system.

For example, referring to FIGS. 5A, 5B, 6 and 7, selector engine 205 would select path 2 501B as opposed to path 1 501A because the time difference between snapshots 401B-401C corresponding to states W and B (identified as 403B, 403C, respectively, in FIG. 7) was 5 hours and the time difference between states W and B (identified as states 301D, 301F in state diagram 300) in path 1 501A was 19 hours; whereas, the time difference between states W and B (identified as states 301D, 301F in state diagram 300) in path 2 501B was 5 hours, which is much closer to the time difference (5 hours) between snapshots 401B-401C corresponding to states W and B (identified as 403B, 403C, respectively, in FIG. 7).

Furthermore, it is noted that the time difference between snapshots 401A-401B corresponding to states A and W (identified as 403A, 403B, respectively, in FIG. 7) was 3 hours which is less than the time difference (4 hours) between states A and W (identified as states 301A, 301D, respectively, in state diagram 300) in paths 1 and 2 (501A, 501B, respectively). Hence, it may also be inferred that the faster path was taken by the system from state W to state B (identified as states 301D, 301F, respectively, in state diagram 300) in path 2 501B versus the slower path of path 1 501A.

As stated above, in one embodiment, selector engine 205 is configured to select the transition path out of the identified possible transition paths whose time duration between the states identified in snapshots 401 is the closest to the time duration between the snapshot times for such states.

In one embodiment, selector engine 205 utilizes various software tools for selecting one of the possible transition paths in the state diagram, such as state diagram 300, based on the calculated time difference between the states identified in snapshots 401 in each of the identified possible transition paths and the calculated time difference between each of the snapshots 401 of the system, including, but not limited to, Lucidchart®, IBM® Rational Rhapsody, etc.

In operation 907, predictor engine 206 of manufacturing analysis system 102 determines the transition times between the states of the selected transition path (transition path selected by selector engine 205, such as path 2 501B) that are within the selected states (e.g., states A and W) of snapshots 401 as a percentage of the typical time taken by the system between the selected states (e.g., states A and W) of snapshots 401.

For example, the system took 3 hours to transition between state A (identified as 403A in FIG. 7) and state W (identified as 403B in FIG. 7) according to snapshots 401 of the system as shown in FIG. 7. As previously discussed in connection with FIGS. 5B and 6, the typical time that the system transitions between states A and W (identified as 301A, 301D, respectively, in state diagram 300) using path 2 501B (selected transition path) is 4 hours. As further illustrated in FIGS. 3, 5B and 6, the system transitions between various states within the selected states of A and W. For example, the system transitions between states A and Z (301A, 301B), between states Z and Y (301B, 301C) and between states Y and W (301C, 301D). Furthermore, as illustrated in FIGS. 5B and 6, the time duration for the transition between states A and Z (301A, 301B) for the selected path (path 2 501B) is 1 hour, the time duration for the transition between states Z and Y (301B, 301C) for the selected path (path 2 501B) is 2 hours and the time duration for the transition between states Y and W (301C, 301D) for the selected path (path 2 501B) is 1 hour. Hence, the typical time duration for the system to transition between the selected states A and W for the selected path (path 2 501B) is 4 hours (total time for transitioning between the selected states, A and W, of snapshots 401). Hence, the percentage of the total typical time for the transitions between the states between the selected states, such as states A and W, of snapshots 401 is the following:
% of the total for transitioning between states A and Z is 1 hour/4 hours=25%
% of the total for transitioning between states Z and Y is 2 hours/4 hours=50%
% of the total for transitioning between states Y and W is 1 hour/4 hours=25%

Since the actual time of the transition between states A and W is 3 hours as identified by snapshots 401, the time to transition from state A to state Z is 25%*3 hours=0.75 hours (45 minutes), the time to transition from state Z to state Y is 50%*3 hours=1.5 hours, and the time to transition from state Y to state W is 25%*3 hours=0.75 hours (45 minutes).

In operation 908, predictor engine 206 of manufacturing analysis system 102 determines a predicted time that the system entered each state of the selected transition path (e.g., path 501B) within the selected states (e.g., states A, W) of snapshots 401 based on the determined transition times (see operation 907) and based on the time difference between the selected states (e.g., states A, W) of snapshots 401 (see operation 905).

In one embodiment, such predicted times may be used to identify products that were processed in the same batch or in a similar timeframe, identify the work shift or team that performed a business step, etc.

For example, as illustrated in FIG. 7, it took 3 hours for the system to transition between states A and W (403A, 403B, respectively). Furthermore, as illustrated in FIG. 7, snapshot 401A indicates that time TO 402A (corresponding to state A) occurred at 8 AM and snapshot 401B indicates that time T1 402B (corresponding to state W) occurred at 11 AM. In one embodiment, it is assumed that the time of a snapshot 401, such as 11 AM for time T1 402B, corresponds to the time that the system started in state W (identified as 403B in FIG. 7). Based on such information and assumptions as well as the transition times between the states (e.g., transition time between states A and Z is 45 minutes, transition time between states Z and Y is 1.5 hours and transition time between states Y and W is 45 minutes) of the selected transition path (e.g., path 2 501B), predictor engine 206 determines that the system entered state A at 8 AM (obtained from snapshot 401A), entered state Z at 8:45 AM (transition time between states A and Z is 45 minutes), entered state Y at 10:15 AM (transition time between states Z and Y is 1.5 hours) and entered state W at 11:00 AM (transition time between states Y and W is 45 minutes) (corresponds to the time at snapshot 401B).

In one embodiment, predictor engine 206 is configured to determine such features using various software tools, including, but not limited to, time difference calculator, My Alarm Clock percentage calc, etc.

In operation 909, predictor engine 206 of manufacturing analysis system 102 predicts an issue related to the manufacturing process based on the predicted time that the system entered each state between the selected states (e.g., states A, W) of snapshots 401.

For example, as discussed above, predictor engine 206 may determine that the system entered state A at 8 AM (obtained from snapshot 401A), entered state Z at 8:45 AM (transition time between states A and Z is 45 minutes), entered state Y at 10:15 AM (transition time between states Z and Y is 1.5 hours) and entered state W at 11:00 AM (transition time between states Y and W is 45 minutes) (corresponds to the time at snapshot 401B). Based on such time durations between such states, predictor engine 206 may determine if there is an issue related to the manufacturing process (e.g., margin and process variations, photolithography errors, wafer defects, etc.).

As stated above, in one embodiment, a data structure (e.g., table) includes a listing of issues related to the manufacturing process and the times that the system entered various states. For example, the issue of a margin and process variation may be associated with the system entering state A at 8:00 AM, entering state Z at 8:45 AM, entering state Y at 10:15 AM and entering state W at 11:00 AM. In one embodiment, predictor engine 206 analyzes the data structure for times that match the predicted times (discussed above) for entering the same states. Such a matching result in the data structure may be associated with an issue, such as a photolithography error. In this manner, predictor engine 206 is able to identify an issue (e.g., photolithography error). In one embodiment, such a data structure is populated by an expert. In one embodiment, such a data structure resides within the storage device (e.g., storage device 811, 815) of manufacturing analysis system 102.

In one embodiment, a data structure (e.g., table) includes a listing of issues related to the manufacturing process and the time differences between the states transitioned by the system during the manufacturing process. For example, based on entering states A, Z, Y and W at 8 AM, 8:45 AM, 10:15 AM and 11 AM, respectively, it can be inferred that it took 45 minutes to transition between states A and Z, took 1.5 hours to transition between states Z and Y and took 45 minutes to transition between states Y and W. In one embodiment, predictor engine 206 analyzes the data structure for time durations that match the time durations between the predicted times (discussed above) for the states entered by the system. For example, predictor engine 206 analyzes the data structure for matching the time duration of 45 minutes to transition between states A and Z, the time duration of 1.5 hours to transition between states Z and Y and the time duration of 45 minutes to transition between states Y and W. Such matching time durations may result in identifying an issue (e.g., photolithography error) in the data structure. In this manner, predictor engine 206 is able to identify an issue (e.g., photolithography error). In one embodiment, such a data structure is populated by an expert. In one embodiment, such a data structure resides within the storage device (e.g., storage device 811, 815) of manufacturing analysis system 102.

In one embodiment, predictor engine 206 trains a model to identify an issue (e.g., margin and process variations, photolithography errors, wafer defects, etc.) related to the manufacturing process based on the predicted time that the system entered each state between the selected states (e.g., states A, W) of snapshots 401.

In one embodiment, predictor engine 206 uses a machine learning algorithm (e.g., supervised learning) to build the model to identify an issue (e.g., margin and process variations, photolithography errors, wafer defects, etc.) related to the manufacturing process using a sample data set containing predicted times that the system entered each state.

Such a sample data set is referred to herein as the “training data,” which is used by the machine learning algorithm to make predictions or decisions as to the issue (e.g., margin and process variations, photolithography errors, wafer defects, etc.) related to the manufacturing process based on the predicted time that the system entered each state between the selected states (e.g., states A, W) of snapshots 401. The algorithm iteratively makes predictions on the training data as to the issue (e.g., margin and process variations, photolithography errors, wafer defects, etc.) related to the manufacturing process based on the predicted time that the system entered each state between the selected states (e.g., states A, W) of snapshots 401. Examples of such learning algorithms include nearest neighbor, Naïve Bayes, decision trees, linear regression, support vector machines and neural networks.

In one embodiment, after training the model to identify an issue (e.g., margin and process variations, photolithography errors, wafer defects, etc.) related to the manufacturing process based on the predicted time that the system entered each state between the selected states of snapshots 401, predictor engine 206 inputs the predicted time that the system entered each state of the selected transition path (e.g., transition path 501B) within the selected states of snapshots 401 to the model. The model then outputs an issue related to the manufacturing process if such an issue is related to such predicted times.

In this manner, a manufacturing process is modeled using the snapshots of the system to perform manufacturing analysis. Such a manufacturing analysis may be performed to identify any issues (e.g., margin and process variations, photolithography errors, wafer defects, etc.) related to the manufacturing process. For example, the manufacturing analysis may be performed on the modeled manufacturing process to identify processor chips that have been processed with a known defective process which may be inferred based on the predicted time that the system enters particular states of the system. For example, processor chips that have been processed with a known defective process may be identified based on a time duration that exceeds a threshold amount of time between particular states of the system.

Furthermore, the principles of the present disclosure improve the technology or technical field involving manufacturing analysis. As discussed above, modern manufacturing includes all intermediate processes involved in the production and integration of a product's components. Some industries, such as semiconductor and steel manufacturers, use the term “fabrication” instead. Semiconductor device fabrication is the process used to manufacture semiconductor devices, typically integrated circuit (IC) chips, such as modern computer processors, microcontrollers, and memory chips, such as NAND flash and DRAM, that are present in everyday electrical and electronic devices. It is a multiple-step sequence of photolithographic and chemical processing steps, such as surface passivation, thermal oxidation, planar diffusion and junction isolation, during which electronic circuits are gradually created on a wafer made of pure semiconducting material. Silicon is almost always used, but various compound semiconductors are used for specialized applications. The semiconductor manufacturing process is performed in highly specialized semiconductor fabrication plants, also called foundries or fabs. All fabrication takes place inside a clean room, which is the central part of a fab. Production in advanced fabrication facilities is completely automated and carried out in a hermetically sealed nitrogen environment to improve yield (the percent of microchips that function correctly in a wafer), with automated material handling systems taking care of the transport of wafers from machine to machine. Wafers are transported inside FOUPs (Front Opening Unified Pods), special sealed plastic boxes. All machinery and FOUPs contain an internal nitrogen atmosphere. The air inside the machinery and FOUPs is usually kept cleaner than the surrounding air in the cleanroom. This internal atmosphere is known as a mini-environment. Fabrication plants need large amounts of liquid nitrogen to maintain the atmosphere inside production machinery and FOUPs, which is constantly purged with nitrogen. At times, the yield (the percent of microchips that function correctly in a wafer) in the semiconductor manufacturing process is poor, even as low as 5%. In such situations, an analysis, such as a fault and failure analysis, is performed to determine the cause of such a poor yield, such as margin and process variations, photolithography errors, wafer defects, etc. However, in order to properly perform the fault and failure analysis, access to all the data pertaining to the process steps is required. Unfortunately, such as in situations in which manufacturing is performed by a third party, access to such data may be limited thereby preventing a complete and thorough manufacturing analysis to identify an issue related to the manufacturing process, such as the cause of a poor yield. For example, the third party may provide a highly redacted data stream to prevent the sharing of process specifics thereby preventing a complete and thorough manufacturing analysis to identify an issue (e.g., margin and process variation) related to the manufacturing process.

Embodiments of the present disclosure improve such technology by receiving snapshots of the system, where each snapshot includes a time that the snapshot was taken and a state of the system at that time. In one embodiment, such snapshots may correspond to sporadic snapshots of the process data, such as snapshots of the manufacturing process (e.g., semiconductor manufacturing process). A “snapshot,” as used herein, refers to data taken at a moment in time involving a manufacturing process, such as a semiconductor manufacturing process. A “state” may represent a step in the manufacturing process, a change in the location of an entity, a change in the composition of an entity or a business process step. Possible transitions paths in a state diagram exhibited by the system are then identified based on the snapshots of the system. A “state diagram,” as used herein, is a diagram describing the behavior of the system. A “transition path,” as used herein, refers to the sequence of state changes exhibited by the system. In one embodiment, such possible transition paths are identified based on the system states at the times of the snapshots of the system. A transition path out of the identified possible transition paths that most likely corresponds to the sequence of state changes exhibited by the system is then selected based on information pertaining to a typical time taken by the system from one state to another. For example, in one embodiment, a time difference between the states identified in the snapshots in each of the identified possible transition paths is calculated based on the information pertaining to the typical time taken by the system from one state to another. Furthermore, a time difference between each snapshot of the system is calculated. A transition path out of the identified possible transition paths that most likely corresponds to the sequence of state changes exhibited by the system is selected based on such calculated times. A predicted time that the system entered each state of the selected transition path between the selected states of the snapshots is then determined based on the information pertaining to the typical time taken by the system from one state to another as well as the time at which each of the snapshots was taken. For example, in one embodiment, transition times between the states of the selected transition path within the selected states of the snapshots is determined as a percentage of the typical time between the selected states of the snapshots. The predicted time that the system enters each of these states is determined based on the determined transition times between the states of the selected transition path within the selected states of the snapshots as well as based on the time difference between the selected states of the snapshots. An issue related to the manufacturing process (e.g., margin and process variations, photolithography errors, wafer defects, etc.) may be predicted based on the predicted time that the system entered each state between the selected states of the snapshots. For example, in one embodiment, a data structure (e.g., table) includes a listing of issues related to the manufacturing process and the times that the system entered various states. For instance, the issue of a margin and process variation may be associated with the system entering state A at 8:00 AM, entering state Z at 8:45 AM, entering state Y at 10:15 AM and entering state W at 11:00 AM. Such a data structure may be analyzed for times that match the predicted times (discussed above) for entering the same states. Such a matching result in the data structure may be associated with an issue, such as photolithography error. Alternatively, in one embodiment, a model is trained to identify an issue (e.g., margin and process variations, photolithography errors, wafer defects, etc.) related to the manufacturing process based on the predicted time that the system entered each state between the selected states of the snapshots. Based on the predicted times that the system entered each state in the system as discussed above, the trained model will output an issue related to the manufacturing process if such an issue is related to such predicted times. In this manner, a manufacturing process is modeled using the snapshots of the system to perform a manufacturing analysis. Such a manufacturing analysis may be performed to identify any issues (e.g., margin and process variations, photolithography errors, wafer defects, etc.) related to the manufacturing process. Furthermore, in this manner, there is an improvement in the technical field involving manufacturing analysis.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

In one embodiment of the present disclosure, a computer-implemented method for modeling a manufacturing process comprises receiving a plurality of snapshots of a system, where each of the plurality of snapshots comprises a time at which a snapshot was taken and a state of the system at the time. The method further comprises identifying one or more possible transition paths in a state diagram based on the plurality of snapshots of the system. The method additionally comprises selecting a first transition path from the identified one or more possible transition paths in the state diagram based on information pertaining to a typical time taken by the system to transition from one state to another and the time at which each of the plurality of snapshots was taken. Furthermore, the method comprises determining a predicted time that the system entered each state in the first transition path within selected states of the plurality of snapshots based on the information pertaining to the typical time taken by the system to transition from one state to another and the time at which each of the plurality of snapshots was taken.

Furthermore, in one embodiment of the present disclosure, the method additionally comprises predicting an issue related to the manufacturing process based on the predicted time that the system entered each state in the first transition path within the selected states of the plurality of snapshots.

Additionally, in one embodiment of the present disclosure, the method further comprises identifying the one or more possible transition paths in the state diagram based on the state of the system at each time the snapshot was taken.

Furthermore, in one embodiment of the present disclosure, the method additionally comprises creating the state diagram describing a behavior of the system from a moderated queue, where the state diagram comprises states for the system and transitions between the states, where the moderated queue comprises information pertaining to the states of the system and the transitions between the states, where the moderated queue further comprises information pertaining to the typical time taken by the system from one state to another.

Additionally, in one embodiment of the present disclosure, the method further comprises calculating a time difference between states identified in the plurality of snapshots of the system in each of the identified one or more possible transition paths based on the information pertaining to the typical time taken by the system from one state to another. The method additionally comprises calculating a time difference between each of the plurality of snapshots of the system.

Furthermore, in one embodiment of the present disclosure, the method additionally comprises selecting the first transition path from the identified one or more possible transition paths in the state diagram based on the calculated time difference between states identified in the plurality of snapshots of the system and the calculated time difference between each of the plurality of snapshots of the system.

Additionally, in one embodiment of the present disclosure, the method further comprises calculating a time difference between the selected states identified in the plurality of snapshots of the system. The method additionally comprises determining a predicted time that the system entered each state in the first transition path within the selected states of the plurality of snapshots based on the information pertaining to the typical time taken by the system from one state to another and the calculated time difference between the selected states identified in the plurality of snapshots of the system.

Furthermore, in one embodiment of the present disclosure, the calculated time difference between the selected states identified in the plurality of snapshots of the system corresponds to a time difference between a first snapshot and a second snapshot of the system, where the time difference between the first snapshot and the second snapshot of the system encompasses a transition between a first state and a second state and a transition between the second state and a third state of the first transition path. The method further comprises determining a transition time between the first and second states and between the second and third states of the first transition path as a percentage of the typical time taken by the system between the first and second snapshots of the system multiplied by the time difference between the first and second snapshots of the system.

Additionally, in one embodiment of the present disclosure, the method further comprises determining the predicted time that the system entered the first, second and third states of the first transition path based on the transition time between the first and second states and between the second and third states of the first transition path and the time at which the first and second snapshots of the system were taken.

Other forms of the embodiments of the computer-implemented method described above are in a system and in a computer program product.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for modeling a manufacturing process, the method comprising:
receiving a plurality of snapshots of a system, wherein each of said plurality of snapshots comprises a time at which a snapshot was taken and a state of said system at said time;
identifying one or more possible transition paths in a state diagram based on said plurality of snapshots of said system;
selecting a first transition path from said identified one or more possible transition paths in said state diagram based on information pertaining to a typical time taken by said system to transition from one state to another and said time at which each of said plurality of snapshots was taken; and
determining a predicted time that said system entered each state in said first transition path within selected states of said plurality of snapshots based on said information pertaining to said typical time taken by said system to transition from one state to another and said time at which each of said plurality of snapshots was taken.

2. The method as recited in claim 1 further comprising:
predicting an issue related to said manufacturing process based on said predicted time that said system entered each state in said first transition path within said selected states of said plurality of snapshots.

3. The method as recited in claim 1 further comprising:
identifying said one or more possible transition paths in said state diagram based on said state of said system at each time said snapshot was taken.

4. The method as recited in claim 1 further comprising:
creating said state diagram describing a behavior of said system from a moderated queue, wherein said state diagram comprises states for said system and transitions between said states, wherein said moderated queue comprises information pertaining to said states of said system and said transitions between said states, wherein said moderated queue further comprises information pertaining to said typical time taken by said system from one state to another.

5. The method as recited in claim 1 further comprising:
calculating a time difference between states identified in said plurality of snapshots of said system in each of said identified one or more possible transition paths based on said information pertaining to said typical time taken by said system from one state to another; and
calculating a time difference between each of said plurality of snapshots of said system.

6. The method as recited in claim 5 further comprising:
selecting said first transition path from said identified one or more possible transition paths in said state diagram based on said calculated time difference between states identified in said plurality of snapshots of said system and said calculated time difference between each of said plurality of snapshots of said system.

7. The method as recited in claim 1 further comprising:
calculating a time difference between said selected states identified in said plurality of snapshots of said system; and
determining a predicted time that said system entered each state in said first transition path within said selected states of said plurality of snapshots based on said information pertaining to said typical time taken by said system from one state to another and said calculated time difference between said selected states identified in said plurality of snapshots of said system.

8. The method as recited in claim 7, wherein said calculated time difference between said selected states identified in said plurality of snapshots of said system corresponds to a time difference between a first snapshot and a second snapshot of said system, wherein said time difference between said first snapshot and said second snapshot of said system encompasses a transition between a first state and a second state and a transition between said second state and a third state of said first transition path, wherein the method further comprises:
determining a transition time between said first and second states and between said second and third states of said first transition path as a percentage of said typical time taken by said system between said first and second snapshots of said system multiplied by said time difference between said first and second snapshots of said system.

9. The method as recited in claim 8 further comprising:
determining said predicted time that said system entered said first, second and third states of said first transition path based on said transition time between said first and second states and between said second and third states of said first transition path and said time at which said first and second snapshots of said system were taken.

10. A computer program product for modeling a manufacturing process, the computer program product comprising one or more computer readable storage mediums having program code embodied therewith, the program code comprising programming instructions for:
receiving a plurality of snapshots of a system, wherein each of said plurality of snapshots comprises a time at which a snapshot was taken and a state of said system at said time;
identifying one or more possible transition paths in a state diagram based on said plurality of snapshots of said system;
selecting a first transition path from said identified one or more possible transition paths in said state diagram based on information pertaining to a typical time taken by said system to transition from one state to another and said time at which each of said plurality of snapshots was taken; and
determining a predicted time that said system entered each state in said first transition path within selected states of said plurality of snapshots based on said information pertaining to said typical time taken by said system to transition from one state to another and said time at which each of said plurality of snapshots was taken.

11. The computer program product as recited in claim 10, wherein the program code further comprises the programming instructions for:
predicting an issue related to said manufacturing process based on said predicted time that said system entered each state in said first transition path within said selected states of said plurality of snapshots.

12. The computer program product as recited in claim 10, wherein the program code further comprises the programming instructions for:
identifying said one or more possible transition paths in said state diagram based on said state of said system at each time said snapshot was taken.

13. The computer program product as recited in claim 10, wherein the program code further comprises the programming instructions for:
creating said state diagram describing a behavior of said system from a moderated queue, wherein said state diagram comprises states for said system and transitions between said states, wherein said moderated queue comprises information pertaining to said states of said system and said transitions between said states, wherein said moderated queue further comprises information pertaining to said typical time taken by said system from one state to another.

14. The computer program product as recited in claim 10, wherein the program code further comprises the programming instructions for:
calculating a time difference between states identified in said plurality of snapshots of said system in each of said identified one or more possible transition paths based on said information pertaining to said typical time taken by said system from one state to another; and
calculating a time difference between each of said plurality of snapshots of said system.

15. The computer program product as recited in claim 14, wherein the program code further comprises the programming instructions for:
selecting said first transition path from said identified one or more possible transition paths in said state diagram based on said calculated time difference between states identified in said plurality of snapshots of said system and said calculated time difference between each of said plurality of snapshots of said system.

16. The computer program product as recited in claim 10, wherein the program code further comprises the programming instructions for:
calculating a time difference between said selected states identified in said plurality of snapshots of said system; and
determining a predicted time that said system entered each state in said first transition path within said selected states of said plurality of snapshots based on said information pertaining to said typical time taken by said system from one state to another and said calculated time difference between said selected states identified in said plurality of snapshots of said system.

17. The computer program product as recited in claim 16, wherein said calculated time difference between said selected states identified in said plurality of snapshots of said system corresponds to a time difference between a first snapshot and a second snapshot of said system, wherein said time difference between said first snapshot and said second snapshot of said system encompasses a transition between a first state and a second state and a transition between said second state and a third state of said first transition path, wherein the program code further comprises the programming instructions for:
determining a transition time between said first and second states and between said second and third states of said first transition path as a percentage of said typical time taken by said system between said first and second snapshots of said system multiplied by said time difference between said first and second snapshots of said system.

18. A system, comprising:
a memory for storing a computer program for modeling a manufacturing process; and
a processor connected to said memory, wherein said processor is configured to execute program instructions of the computer program comprising:
receiving a plurality of snapshots of a system, wherein each of said plurality of snapshots comprises a time at which a snapshot was taken and a state of said system at said time;
identifying one or more possible transition paths in a state diagram based on said plurality of snapshots of said system;
selecting a first transition path from said identified one or more possible transition paths in said state diagram based on information pertaining to a typical time taken by said system to transition from one state to another and said time at which each of said plurality of snapshots was taken; and
determining a predicted time that said system entered each state in said first transition path within selected states of said plurality of snapshots based on said information pertaining to said typical time taken by said system to transition from one state to another and said time at which each of said plurality of snapshots was taken.

19. The system as recited in claim 18, wherein the program instructions of the computer program further comprise:
predicting an issue related to said manufacturing process based on said predicted time that said system entered each state in said first transition path within said selected states of said plurality of snapshots.

20. The system as recited in claim 18, wherein the program instructions of the computer program further comprise:
identifying said one or more possible transition paths in said state diagram based on said state of said system at each time said snapshot was taken.

21. The system as recited in claim 18, wherein the program instructions of the computer program further comprise:
creating said state diagram describing a behavior of said system from a moderated queue, wherein said state diagram comprises states for said system and transitions between said states, wherein said moderated queue comprises information pertaining to said states of said system and said transitions between said states, wherein said moderated queue further comprises information pertaining to said typical time taken by said system from one state to another.

22. The system as recited in claim 18, wherein the program instructions of the computer program further comprise:
calculating a time difference between states identified in said plurality of snapshots of said system in each of said identified one or more possible transition paths based on said information pertaining to said typical time taken by said system from one state to another; and
calculating a time difference between each of said plurality of snapshots of said system.

23. The system as recited in claim 22, wherein the program instructions of the computer program further comprise:
selecting said first transition path from said identified one or more possible transition paths in said state diagram based on said calculated time difference between states identified in said plurality of snapshots of said system and said calculated time difference between each of said plurality of snapshots of said system.

24. The system as recited in claim 18, wherein the program instructions of the computer program further comprise:
calculating a time difference between said selected states identified in said plurality of snapshots of said system; and
determining a predicted time that said system entered each state in said first transition path within said selected states of said plurality of snapshots based on said information pertaining to said typical time taken by said system from one state to another and said calculated time difference between said selected states identified in said plurality of snapshots of said system.

25. The system as recited in claim 24, wherein said calculated time difference between said selected states identified in said plurality of snapshots of said system corresponds to a time difference between a first snapshot and a second snapshot of said system, wherein said time difference between said first snapshot and said second snapshot of said system encompasses a transition between a first state and a second state and a transition between said second state and a third state of said first transition path, wherein the program instructions of the computer program further comprise:
determining a transition time between said first and second states and between said second and third states of said first transition path as a percentage of said typical time taken by said system between said first and second snapshots of said system multiplied by said time difference between said first and second snapshots of said system.
